(19) United States
(12) Patent Application Publication
(10) Pub. No.: US 2024/0317327 A1
(43) Pub. Date: Sep. 26, 2024

(54) SUSPENDED BULKHEADS FOR ENCLOSED CARGO TRANSPORTERS

(71) Applicant: Rite-Hite Holding Corporation, Milwaukee, WI (US)

(72) Inventors: Gary Borgerding, Dubuque, IA (US); Bruce Henning, Dubuque, IA (US); Jared Lueken, Dyersville, IA (US); Frank Heim, Platteville, WI (US); Matt Manone, Denver, CO (US); Charles J. Ashelin, Dubuque, IA (US); Collin Thole, Lancaster, WI (US)

(21) Appl. No.: 18/187,542

(22) Filed: Mar. 21, 2023

Related U.S. Application Data
(63) Continuation of application No. PCT/US2021/051373, filed on Sep. 21, 2021.
(60) Provisional application No. 63/081,165, filed on Sep. 21, 2020.
(60) Provisional application No. 63/138,133, filed on Jan. 15, 2021.

(51) Int. Cl. B62D 33/04

(52) U.S. Cl. CPC B62D 33/042; B62D 33/048

(57) ABSTRACT

Example bulkheads for cargo transporters (e.g., refrigerated trailers, trucks, reefers, and containers) are disclosed. An example bulkhead includes an overhead track system mountable to an enclosed cargo transporter within a cargo storage area. A first carriage is attached to the overhead track system. The first carriage is movable relative to the overhead track system in at least one of a lateral direction or a longitudinal direction while being guided by the overhead track system. A first panel is suspended by the first carriage from the overhead track system, where the weight of the first panel is substantially supported by the overhead track system via the first carriage.

### CROSS-REFERENCE TO RELATED APPLICATIONS

This patent arises as a continuation application of International Patent Application Serial Number PCT/2021/051373, filed on Sep. 21, 2021, which claims the benefit of U.S. Provisional Patent Application No. 63/081,165 filed on Sep. 21, 2020 and U.S. Provisional Patent Application No. 63/138,133, filed on Jan. 15, 2021. Priority to International Patent Application Serial Number PCT/2021/051373, U.S. Provisional Patent Application No. 63/081,165 and U.S. Provisional Patent Application No. 63/138,133 is hereby claimed. International Patent Application Serial Number PCT/2021/051373, U.S. Provisional Patent Application No. 63/081,165 and U.S. Provisional Patent Application No. 63/138,133 are hereby incorporated herein by reference in their entireties.

### FIELD OF THE DISCLOSURE

This disclosure relates generally to enclosed cargo transporters, such as trailers, trucks, and containers and, more particularly, to suspended bulkheads for enclosed cargo transporters.

### BACKGROUND

Bulkheads are movable partitions used inside the cargo storage area of enclosed cargo transporters, such as refrigerated trucks, enclosed trailers, vans, and the like. Some bulkheads are designed to span first and second dimensions (i.e., a cross-sectional plane) of the cargo storage area, so they can divide the storage area into separate compartments along a third dimension of the storage area.

Bulkheads can be thermally insulative, such that adjacent compartments within a cargo transporter can be maintained within different temperature ranges according to the requirements of the cargo. For example, an insulated bulkhead may separate one or more freezer sections, refrigerated sections, ambient temperature sections, and/or various combinations thereof. Some cargo transporters utilize environmental control (e.g., heating, refrigeration, etc.) systems which can include one or more remote heat exchanger units positioned within individual compartments defined/separated by bulkheads to maintain the desired environment (e.g., temperature, humidity, etc.) there within. Providing a cargo transporter with multiple compartments capable of maintaining different environmental conditions, temperature ranges for example, is particularly useful in the food delivery industry. Frozen goods (e.g., ice cream and pizza) can be stored in the freezer section, refrigerated goods (e.g., milk and fresh vegetables) can be kept in the refrigerated section, and dry goods (e.g., cereal and paper towels) can be placed in the ambient temperature section.

To create compartments of various and/or adjustable sizes thereby accommodating particular load proportions (e.g., frozen vs. refrigerated vs. ambient), bulkheads are generally moved manually (e.g., by a dock worker or driver) to different locations within the cargo storage area. Straps on the bulkhead, connectable to tracks or other anchor points on the interior of the cargo storage area, can be used to hold bulkheads in place during transport.

### BRIEF DESCRIPTION OF THE DRAWINGS

FIG. 1 is a perspective view of an example cargo transporter having an example refrigerated trailer hitched to an example tractor.

FIG. 2 is a perspective view similar to FIG. 1 but further showing an example bulkhead installed within an example cargo storage area of the example cargo transporter.

FIG. 3 is a cutaway side view of FIG. 2 with example bulkheads dividing cargo into separate compartments within the example trailer.

FIG. 4 is a cutaway side view similar to FIG. 3 but showing example bulkheads constructed in accordance with teachings disclosed herein.

FIG. 5 is a perspective view of an example strap and clip assembly of the example bulkheads of FIG. 4. The example clip is shown in an example unlatched position relative to an example logistic track of the example bulkheads.

FIG. 6 is a perspective view similar to FIG. 5 but showing the example clip in an example latched position relative to the logistic track.

FIG. 7 is an enlarged view of encircled area-7 of FIG. 4.

FIG. 8 is a cross-sectional view taken along line 8-8 of FIG. 4.

FIG. 9 is a cross-sectional view taken along line 9-9 of FIG. 4. The example strap and clip assemblies are shown in unlatched positions relative to example logistic tracks.

FIG. 10 is a cross-sectional view similar to FIG. 9 but showing the example strap and clip assemblies example latched positions relative to the example logistic tracks.

FIG. 11 is a top view of a portion of the example bulkhead system shown in FIG. 4.

FIG. 12 is a side view of FIG. 11.

FIG. 13 is a cross-sectional view similar to FIG. 9 but showing an example panel of an example bulkhead shifted laterally to an example partially open position.

FIG. 14 is a top view of FIG. 13.

FIG. 15 is a top view similar to FIG. 14 but showing an example panel of an example bulkhead rotated to an example partially open position.

FIG. 16 is a top view similar to FIG. 14 but showing example panels of the example bulkhead rotated and shifted laterally to a first side of the example trailer.

FIG. 17 is a top view similar to FIG. 16 but showing the example panels of the example bulkhead rotated and shifted laterally to opposite sides of the example trailer.

FIG. 18 is a cross-sectional view similar to FIG. 13 but showing the example panels of the example bulkhead rotated and shifted laterally to opposite sides of the example trailer.

FIG. 19 is a cross-sectional top view showing an example magnet seal between example adjacent panels disclosed herein.

FIG. 20 is a cross-sectional top view showing another example magnet seal between example adjacent panels disclosed herein.

FIG. 21 is a cross-sectional view of an example panel disclosed herein taken along line 21-21 of FIG. 9 an example panel.

FIG. 22 is a cross-sectional view similar to FIG. 21 but showing an example worn lower section being replaced by an example new lower section.

FIG. 23 is a cross-sectional view similar to FIG. 7 but showing another example bulkhead disclosed herein.

FIG. 24 is a cross-sectional view similar to FIG. 9 but showing the example bulkhead of FIG. 23.

FIG. 25 is a top view similar to FIG. 11 but showing the example bulkhead of FIG. 23.

FIG. 26 is a top view similar to FIG. 14 but showing the example bulkhead of FIG. 23.

FIG. 27 is a cross-sectional view similar to FIG. 13 but showing the example bulkhead of FIG. 23.

FIG. 28 is a cross-sectional view similar to FIG. 8 but showing another example track system disclosed herein.

FIG. 29 is a cross-sectional view similar to FIG. 28 but showing the example track system shifted in a lateral direction to avoid binding.

FIG. 30 is a cross-sectional view of the example bulkhead of FIG. 9 taken along line 30-30 of FIG. 9.

FIG. 31 is a cross-sectional view similar to FIG. 30 but showing another example side seal disclosed herein.

FIG. 32 is a cross-sectional view similar to FIG. 30 but showing another example side seal disclosed herein.

FIG. 33A is a cross-sectional view similar to FIG. 30 but showing another example side seal disclosed herein.

FIG. 33B is a cross-sectional view similar to FIG. 30 but showing another example side seal disclosed herein.

FIG. 34 is a top view of an example strap and clip assembly disclosed herein shown in latched position.

FIG. 35 is a front view of FIG. 34.

FIG. 36 is a front view similar to FIG. 35 but showing the strap and clip assembly in an example unlatched position.

FIG. 37 is a front view similar to FIG. 36 but showing an example strap of the example strap and clip assembly having restorably broken away from the example panel.

FIG. 38 is a front view of an example panel with an example strap and buckle assembly disclosed herein showing an example buckle of the example strap and buckle assembly is in an example loosened position.

FIG. 39 is a front view similar to FIG. 38 but showing the example buckle in a tightened position.

FIG. 40 is a side view similar to FIG. 7 but showing another example hanger disclosed herein.

FIG. 41 is a side view similar to FIG. 7 but showing another example upper seal member disclosed herein.

FIG. 42 is a side view similar to FIGS. 7 and 41 but showing yet another example upper seal member disclosed herein.

FIG. 43 is a perspective view of another example bulkhead disclosed herein.

FIG. 44A is an enlarged portion of the example bulkhead of FIG. 43 showing an example restraint of the example bulkhead in an example first position.

FIG. 44B is an enlarged portion of the example bulkhead of FIG. 43 showing the example restraint of the example bulkhead in an example second position.

FIG. 45 is a side, perspective view of the example bulkhead of FIG. 43.

FIG. 46A is a perspective view of an example carriage apparatus that can be used to implement the example bulkheads disclosed herein.

FIG. 46B is another perspective view of the example carriage apparatus of FIG. 46A.

FIG. 47A is a perspective view of another example carriage assembly that can be used to implement the example bulkheads disclosed herein.

FIG. 47B is a partial, perspective view of the example carriage assembly of FIG. 47A.

FIG. 47C is another partial, perspective view of the example carriage assembly of FIG. 47B.

FIG. 48 illustrates the example bulkhead of FIGS. 7-20 implemented with an example braking system disclosed herein.

FIG. 49 illustrates the example braking system of FIG. 48 in an example release position.

FIG. 50 illustrates another example flexible panel disclosed herein.

### DETAILED DESCRIPTION

Example bulkheads for cargo transporters (e.g., refrigerated trailers, trucks, reefers, and/or containers) include movable panels suspended from an overhead track system. Example bulkheads disclosed herein divide a storage area of a cargo transporter into separate or isolated storage compartments. Example bulkheads disclosed herein employ example bulkhead panels that can thermally insulated and/or partition separate storage compartments that can be maintained at different temperatures (e.g., a freezer section, a refrigerated section, and an ambient air section). Example overhead track system disclosed herein enable example bulkhead panels disclosed herein to be moved in multiple directions, such as a longitudinal direction along a length of a transporter (e.g., front to back), a lateral direction across a width of a transporter (e.g., side to side), and/or rotated about a vertical axis. Moving the example panels disclosed herein in a longitudinal direction can adjust a size (e.g., an area or square footage) of a storage compartment defined by an example bulkhead. Moving the example panels disclosed herein laterally and/or swiveled about a vertical axis can provide an access opening during loading and/or unloading cargo (e.g., that may otherwise be obstructed by conventional bulkheads). Example bulkhead panels disclosed herein have features including, but not limited to, a replaceable lower section, breakaway retention straps, magnetic seals, conformable or flexible panels, and/or various components and/or track systems.

To facilitate maneuverability of example bulkheads disclosed herein, example bulkhead systems disclosed herein employ a plurality of tracks. For example, example track systems disclosed here can have one or more first tracks and one or more second tracks. For example, example track systems disclosed herein employ one or more first tracks (e.g., lateral tracks) that extend side-to-side across a width (e.g., a full width, a full lateral width, etc.) of a trailer. The example first tracks disclosed herein can be connected together and/or can be substantially parallel relative to each other. For example, the first tracks can include two tracks positioned side-by-side to provide a dual track system. An example dual track system disclosed herein enables a first panel of a bulkhead to be hung from one of the first tracks and a second panel to be hung from a second one of the first tracks, thereby enabling each panel to be hung from a dedicated track and enabling each panel to slid side-to-side in a by-passing fashion. In some examples, a single first track can be used to support a plurality of example panels disclosed herein. For example, a single first track can be used to support two or more panels.

To support the first tracks, example bulkhead systems disclosed herein employ the second tracks. Example first track systems disclosed herein can be positioned along a length of a trailer extending from each corner defined by an interface between the walls and the ceiling. For example, example second tracks (e.g., longitudinal tracks) disclosed herein can be positioned alongside walls of the trailer in a longitudinal direction between a front of the trailer and a rear of the trailer (e.g., at a corner interface between the side walls and a ceiling of a transporter). Example second tracks disclosed herein can be configured to support the one or more first tracks. Example track systems disclosed herein can employ one or more carriages that slidably couple the one or more second tracks and the first tracks. Example carriages disclosed herein can allow one or more second tracks to move in a longitudinal direction within a storage area of a trailer. Thus, example track systems disclosed herein can provide a two-axis track system that enables panels to move side-to-side in a lateral direction and front-to-back in a longitudinal direction within a storage area of a trailer.

Example bulkheads disclosed herein can employ a swivel or pivot joint (e.g., a swivel trolly). Example swivel or pivot joints disclosed herein can couple each panel to one or more example first tracks. Example swivel joints disclosed herein can allow an example panel of a bulkhead to be pivoted or rotated (e.g., 360 degrees) around a vertical axis (e.g., of the swivel joint). Example swivel joints disclosed herein can allow each bulkhead panel to be positioned flat against a side of a trailer to facilitate a loading/unloading operation. In this manner, each panel can either be pushed to opposite sides of a trailer, or both panels can be pushed to a same side of the trailer. This versatility can be beneficial when example bulkheads disclosed herein are stored during a non-temperature controlled loading operation, as the example panels disclosed herein can be stored along walls of the trailer at any point in the trailer, such as a front wall (e.g., a wall opposite a trailer opening). Additionally, example swivel joints disclosed herein enable use of a single first track (e.g., a side-to-side track) or a dual side-to-side track configuration. Example swivel joints disclosed herein provide a center mounting point to enable the panels to swivel to allow a first panel to pass adjacent a second panel in a lateral direction (e.g., a side-to-side direction). Thus, example track systems and swivel joints disclosed herein significantly improve maneuverability of the example panels disclosed herein.

Example bulkheads disclosed herein employ one or more fasteners to store a bulkhead panel when the bulkhead is not in use. For example, one or more fasteners disclosed herein can retain or secure unused panels to a wall of a trailer during loading and/or unloading operating. In some examples, one or more fasteners retain or secure unused panels to prevent the unused panels from moving around when a vehicle is in transit. In some examples, the one or more fasteners can be straps that attach to an anchor (e.g., a track or wall). In some examples, the fasteners including one or more magnets carried by a bulkhead panel that couple to a structure (e.g., a metal track) inside a trailer of a vehicle.

Example bulkheads disclosed herein enables use of less floor space during an opening and/or closing operation of a bulkhead compared to known bulkhead systems (e.g., that employ a hinge). As a result of facilitating the opening/closing operation of the bulkhead, a greater amount of cargo product can be placed in a trailer given that less open floor space is needed to open the bulkhead. Additionally, example bulkheads disclosed herein can be opened can be opened without having to move product out of the way to either hinge a panel to a side or to hinge a panel to a ceiling.

Further, example bulkheads disclosed herein can provide more flexibility for positioning the example panels during a loading/unloading operation. For example, if one or more pallets are spaced apart enough from side to side and front to back of the trailer, the panels can be positioned into place anywhere in the trailer even after the trailer is fully loaded. This could be beneficial when unloading a trailer, as the panels can be moved into a new position prior to removing some product from the trailer. In some examples, this can reduce an amount of time that a “frozen” section of a trailer is left open to warmer air.

Furthermore, example bulkhead panels disclosed herein can include different flexibility characteristics. Specifically, example swivel joint and the example track systems disclosed herein can support a weight of the bulkhead panels, which enable use of a flexible core suspended from a rigid or semi-rigid structure (e.g., a beam at a top) of the panel. The flexibility characteristic of the example panels disclosed herein can withstand more impact than a rigid panel. For example, flexible panels disclosed herein can bend or flex during an impact (e.g., from a forktruck) and do not transfer damaging forces to the tracks system. Thus, impacting the flexible panel can prevent or reduce damage to the first tracks and/or second tracks. Such configuration reduces repair and/or replacement costs.

Some example bulkhead panels disclosed herein can be configured to have portions that have different compressibility and/or flexibility characteristics. For example, a first portion of an example bulkhead panel disclosed herein can include a first foam core (e.g., an upper core) having a first compressibility characteristic and a second foam core (e.g., a lower core) having a second compressibility characteristic different (e.g., greater than) than the first foam characteristic. Thus, example bulkhead panels disclosed herein can be lighter in weight due to the different flexible characteristics, which facilitates maneuverability of the panels in the storage area of the trailer. For example, example bulkhead panels disclosed herein can be bent or folded to maneuver the panels around or over product in a storage area that is loaded in a trailer.

Also, the flexibility characteristics of example bulkhead panels disclosed herein can reduce an amount of friction between a bottom surface of a panel and a floor of the storage area when the bottom surface is in engagement with (e.g., pressed against) the floor, which can facilitate maneuverability of the panels and/or passing of cooling fluid (e.g., air) during a refrigeration process. Moreover, flexible panels disclosed herein facilitate installation of the track systems and/or the panels themselves by providing additional tolerance during sizing of the flexible panels relative to a height of the vehicle or cargo transporter. For example, the flexibility characteristics of a lower portion of example panels disclosed herein allow a panel height to be taller than a height of a storage area and enable the panel to fit given that the lower portion can flex, compress, or bend when positioned within an example storage area, which can simplify manufacturing. For example, flexible panels prevent wedging between a floor and a ceiling if the flexible panels are sized slightly large (e.g., a couple of inches greater than a height of a cargo storage area) as the flexible panel can bend or flex as needed.

Stiffeners or stays can add resilient structure to the flexible panels such that the panel is generally maintained in a flat, planar shape in its normal, installed configuration, can flex to a curved shape in order to avoid damage and allow movement of the panel when sufficient external force is applied, yet is urged back to the flat, planar shape as the external force is removed.

In some examples, flexible panels disclosed herein can include a horizontally-oriented longitudinal stay or stiffener extending along an upper end or edge of the flexible panel. In this manner, the stiffener prevents or restricts lateral edges of the flexible panel from sagging relative to a center of the flexible panel. In this manner, the stiffener disclosed herein maintains an upper edge of the flexible panel in a substantially horizontal orientation (e.g., substantially straight) when the flexible panel is attached to a center pivot. In some examples, the stiffener is a stay, rod (e.g., plastic, fiberglass, a metal, etc.) or other stiffener that is positioned within a pocket or loop adjacent an upper edge of the flexible panel. Example flexible panels disclosed herein can include multiple layers. In some examples, flexible panels disclosed herein can include a polyester batting (e.g., ¾ inch batting) encased in a vinyl coated fabric layer. In some examples, a fiberglass rod (e.g., a horizontal rod) can be inserted in a pocket across the upper edge of the flexible panel to support (e.g., resist sagging) of the outer edges of the flexible panel.

Example panel assemblies disclosed herein define a partition that includes a first panel and a second panel. In some orientations or configurations, the first panel includes a lateral edge that engages or overlaps a lateral edge of the second panel. To couple the first panel and the second panel, some example panels disclosed herein include magnetic or other releaseable fasteners (e.g., hook and loop, snaps, etc.). For example, a first magnetic strip can be positioned along the lateral edge of the first panel and a second magnetic strip can be positioned along the lateral edge of the second panel. The magnetic strips can be employed to removably or temporarily attach the adjacent edges of the first panel and the second panel.

In some examples, flexible panels disclosed herein can include a vertically-oriented longitudinal stay or stiffener extending along a lateral edge of the flexible panel. In this manner, the stiffener prevents or restricts upper and lower edges of the flexible panel from moving significantly out of alignment with each other (front to back). In this manner, the stiffener disclosed herein maintains the lateral edge of the flexible panel in a substantially vertical orientation (e.g., substantially straight) when the flexible panel is attached to a center pivot. In some examples, the stiffener is a stay, rod (e.g., plastic, fiberglass, metal, etc.) or other stiffener that is positioned within a pocket or loops adjacent a lateral edge of the flexible panel. In some examples, the stiffener improves the function of releasable fasteners positioned at overlapping lateral edges of adjacent panels.

Some example track systems disclosed herein include a brake system or apparatus for maintaining a position of a panel assembly in the cargo storage area. For example, to prevent or restrict movement of the panel assembly along the track system when a vehicle is transporting goods, the brake system prevents or restricts movement or shifting of the panels along the track system. A user can manually release the brake (e.g., via a pull cord) to move the panels along the track system or can activate the brake to prevent movement of the panels along the track system.

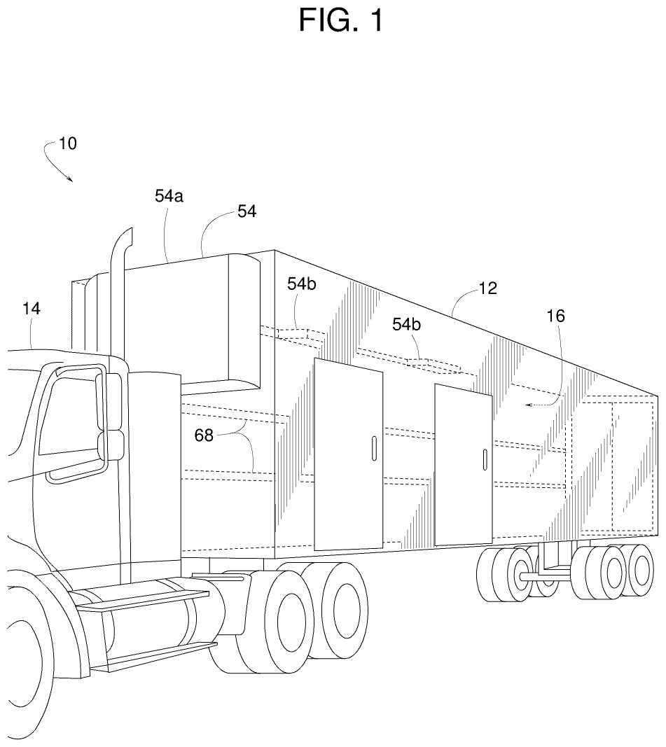

FIGS. 1-4 show an example enclosed cargo transporter 10 having a refrigerated trailer 12 hitched to a tractor 14. Other examples of the cargo transporter 10 include refrigerated trucks, shipping containers, reefers, and/or the like. In the illustrated example, a cargo storage area 16 of the trailer 12 is defined by a ceiling 18, a floor 20, a front wall 22, a back wall 24, and two side walls 36. The cargo storage area 16 has a storage length 28 extending in a longitudinal direction 30 between the front wall 22 and the back wall 24. The cargo storage area 16 has a width 32 (e.g., a storage width) extending in a lateral direction 34 between two side walls 36. The cargo storage area 16 has a storage height 38 extending in a vertical direction 40 between the floor 20 and the ceiling 18. In the illustrated example, a rear door 42 and two side doors 44 provide access to the cargo storage area 16.

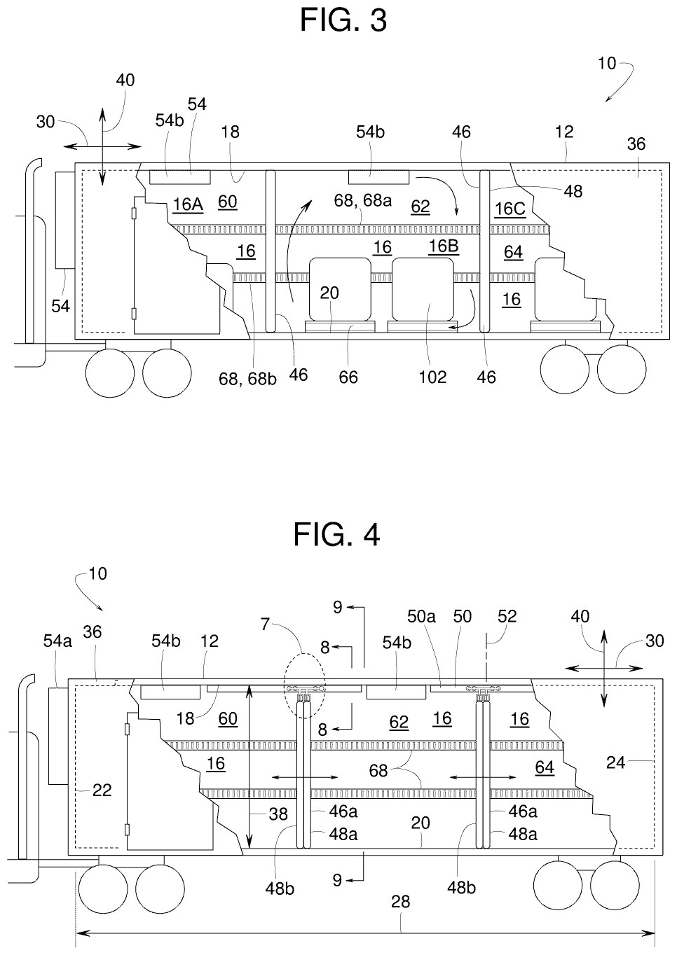

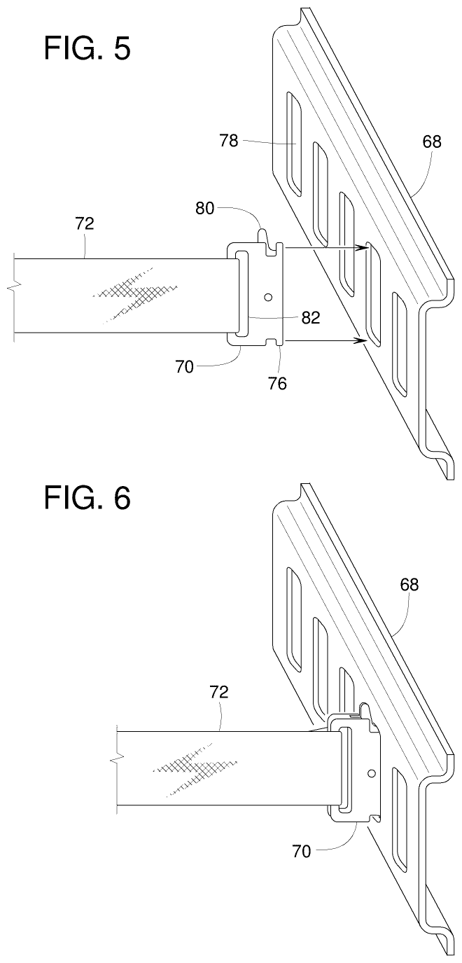

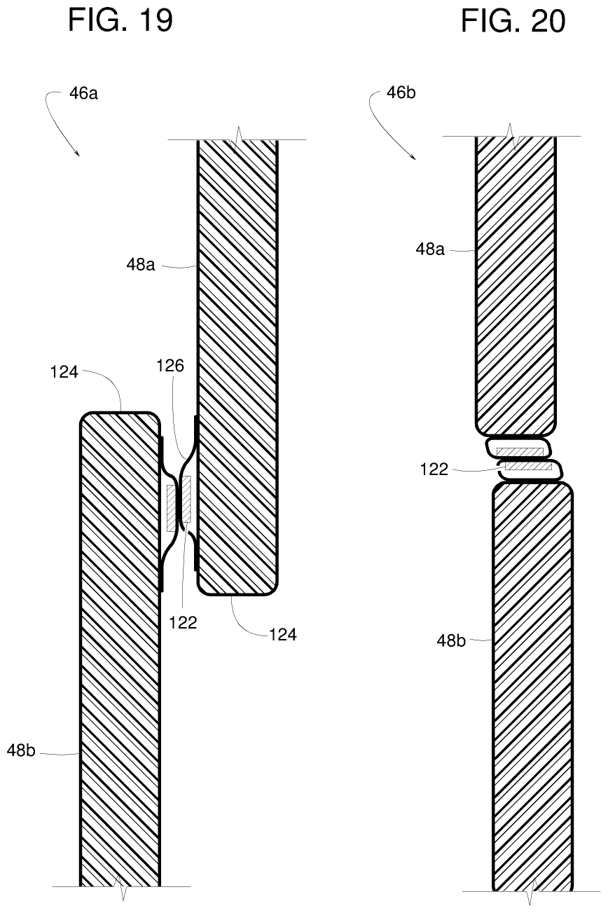

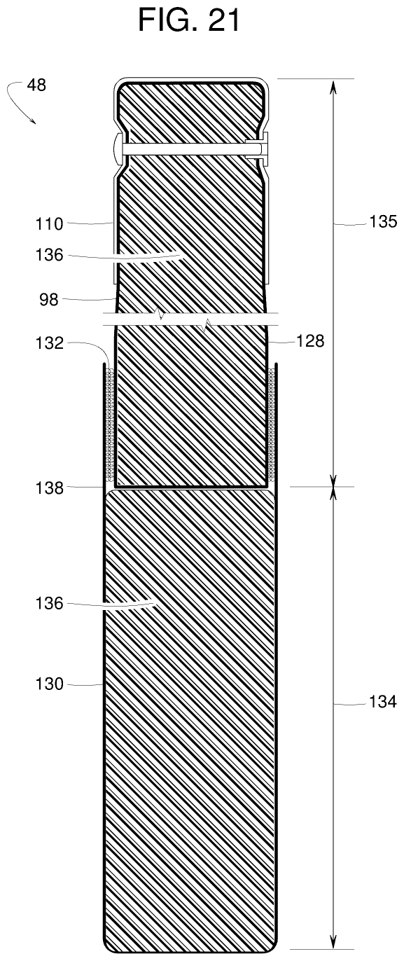

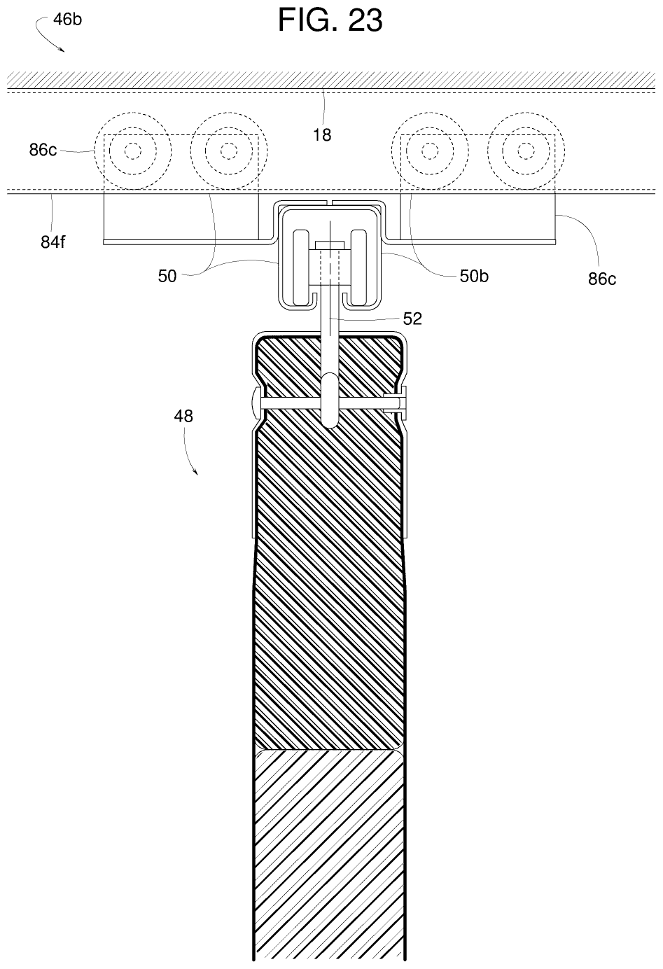

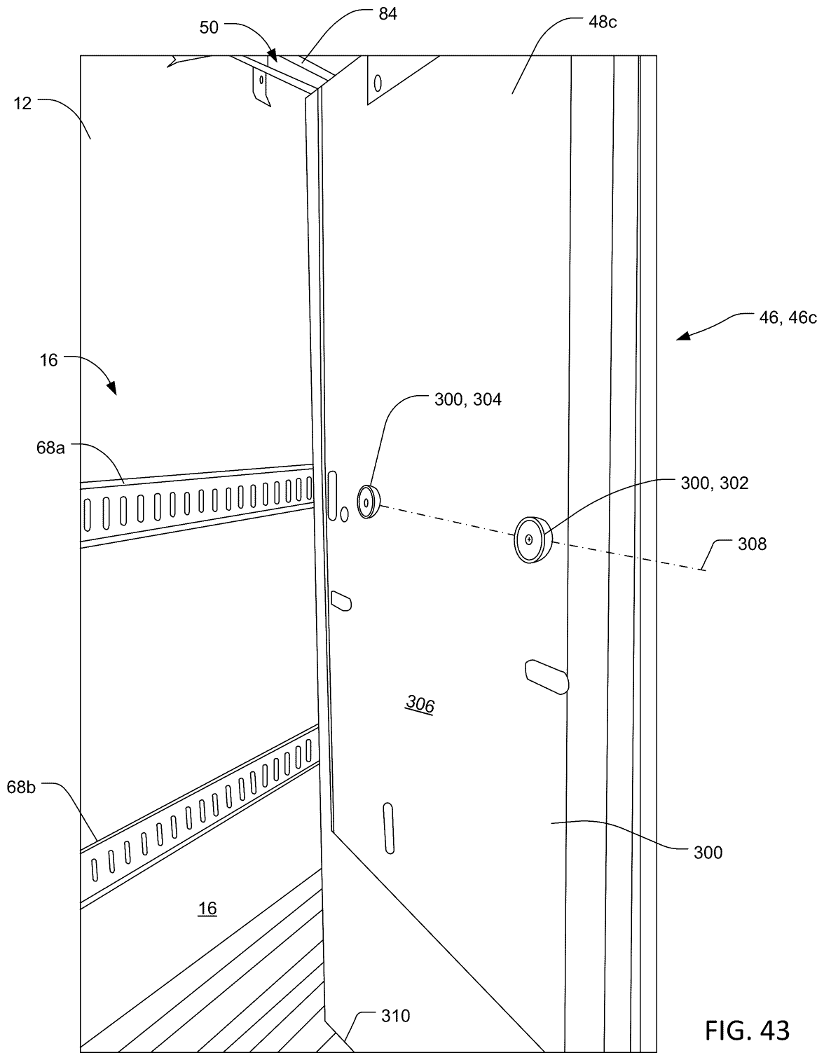

In some examples, one or more example bulkheads 46 (e.g., bulkhead 46a of FIGS. 4 and 7-19, bulkhead 46b of FIGS. 20, 23-27 and bulkhead 46c of FIGS. 43-45) can be used for dividing the cargo storage area 16 into separate compartments 16a-c. For example, the compartments 16a-c can be isolated and/or can be separate, smaller compartments 16a-c (e.g., each configured to have the same area, or each configured to have a different area). In some examples, each of the compartments 16a-c can be kept at a different temperature. Bulkheads 46 include thermally insulated panels 48 (e.g., a first panel 48a and a second panel 48b of FIGS. 3 and 4, a panel 48c of FIGS. 43-45) suspended from an example overhead track system 50 (e.g., overhead track system 50a of FIGS. 4 and 7-18 and overhead track system 50b of FIGS. 23-27). The term “suspended” as it refers to a panel being suspended from an overhead track means that in some instances, at least some of the panel's weight hangs from the overhead track. In some examples, the term suspended means that the panel is supported by an overhead structure such as, for example, a track system (e.g., the overhead track system 50a of FIGS. 4 and 7-18 and overhead track system 50b of FIGS. 23-27).

To adjust a size (e.g., a total area or square footage) of the compartments and/or to provide pass-through access between adjacent compartments, the overhead track system 50 allows the panels 48 to be (e.g., manually) moved within the cargo storage area 16 in the longitudinal direction 30, the lateral direction 34, and/or rotationally about the axis 52. To refrigerate and/or freeze one or more of the separate compartments 16a-c, the trailer 12 includes a transport refrigeration unit 54.

For example, the transport refrigeration unit 54 includes an exterior unit 54a and multiple interior units 54b. The units 54a and 54b are interconnected by tubing to create a closed loop refrigerant circuit that includes a refrigerant compressor and condenser in the exterior unit 54a, an evaporator in each of the interior units 54b, and fluid expansion devices immediately upstream of each of the evaporators.

To cool the cargo storage area 16, evaporator fans of the interior units 54b circulate chilled air to draw heat from within the cargo storage area 16, while a condenser fan of the exterior unit 54a releases the heat outside. In some examples, the exterior unit 54a further includes an integral evaporator that is used as an alternative and/or in addition to the interior units 54b. In some examples, a refrigeration unit (e.g., the transport refrigeration unit 54, the exterior unit 54a, the interior unit 54b) and/or one or more evaporators can be configured to provide heat to the cargo storage area 16 and/or the different compartments 16a-16c to maintain a desired temperature within each of the compartments 16a-c if both heating and cooling are needed.

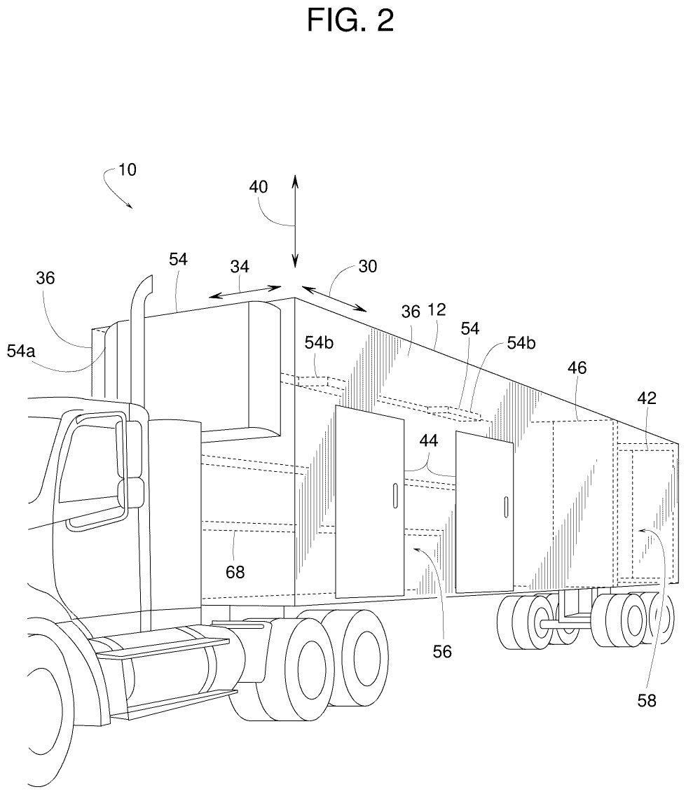

As noted above, one or more example bulkheads 46 can be used for dividing the cargo storage area 16 into multiple compartments 16a-c to be maintained at different temperatures. FIG. 2, for example, shows a single bulkhead 46 installed within the trailer 12 for separating the cargo storage area 16 into a first chamber 56 (e.g., a chilled chamber) having a first temperature (e.g., a temperature that is less than ambient) and a second chamber 58 different that the first chamber 56 having a second temperature (e.g., an ambient temperature section). In this example, both the interior units 54b generate a current of cool (i.e., lower than ambient temperature) air for cooling the chilled first chamber 56. In some examples, the interior units 54b can be configured to generate heat for heating the second chamber 58.

In the examples shown in FIGS. 3 and 4, two bulkheads 46 are installed within the trailer 12 for separating the cargo storage area 16 into the compartments 16a-c (e.g., three chambers) including a freezer section 60 (e.g., below 30 degrees Fahrenheit), a refrigerated section 62 (e.g., between 40-50 degrees Fahrenheit), and an ambient air section 64 (e.g., no temperature requirement). The interior unit 54b and/or an integral evaporator of the exterior unit 54a cools the freezer section 60, another interior unit 54b cools the refrigerated section 62, and the ambient air section 64 is left unconditioned. In some examples, a trailer refrigeration unit and/or evaporator can provide heat to increase a temperature of the ambient air section 64. Some examples of bulkheads 46 are thermally insulated to reduce (e.g., minimize) heat loss between adjacent sections. In some examples, pallets 66 in the cargo storage area 16 that support units of cargo can be used to promote cool air circulation within each cooled compartment.

In addition, or as an alternative to using pallets 66, the floor 20 can be corrugated or otherwise grooved to allow and/or promote cool air circulation. The grooves of the floor 20 can also help channel possible condensate and other liquids from an upper surface of the floor.

FIGS. 1-6 show an upper logistic track 68a and a lower logistic track 68b on both right and left side walls 36 of trailer 12. The logistic tracks 68 are used along with clips 70 and straps 72 as tie-downs for holding the panels 48 of bulkheads 46 in place. Some examples of logistic tracks 68 include E-tracks, F-tracks, A-tracks, L-tracks, and Q'Straint tracks.

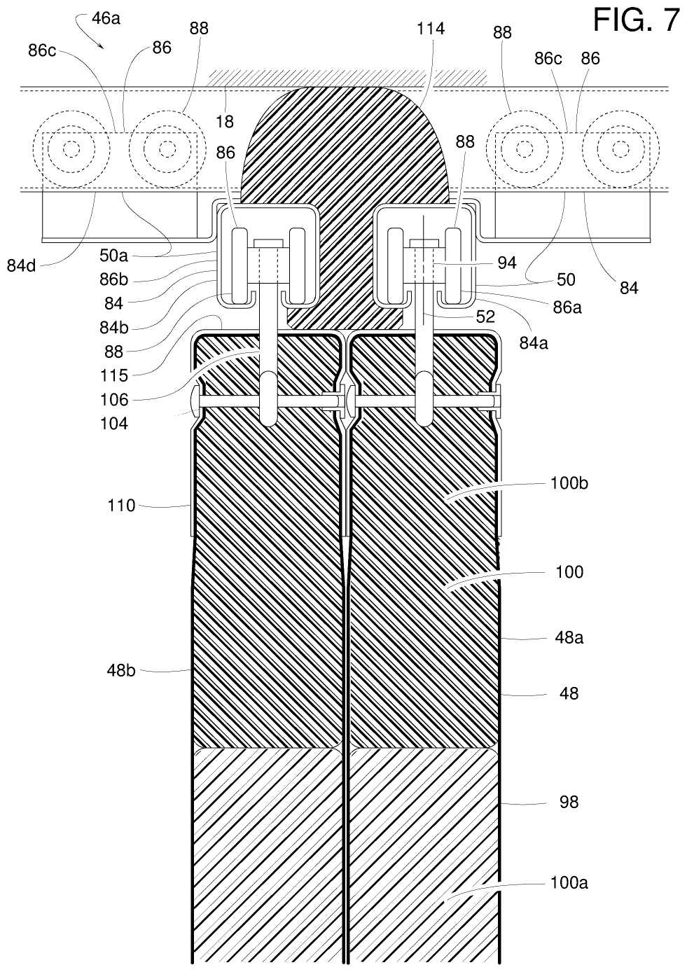

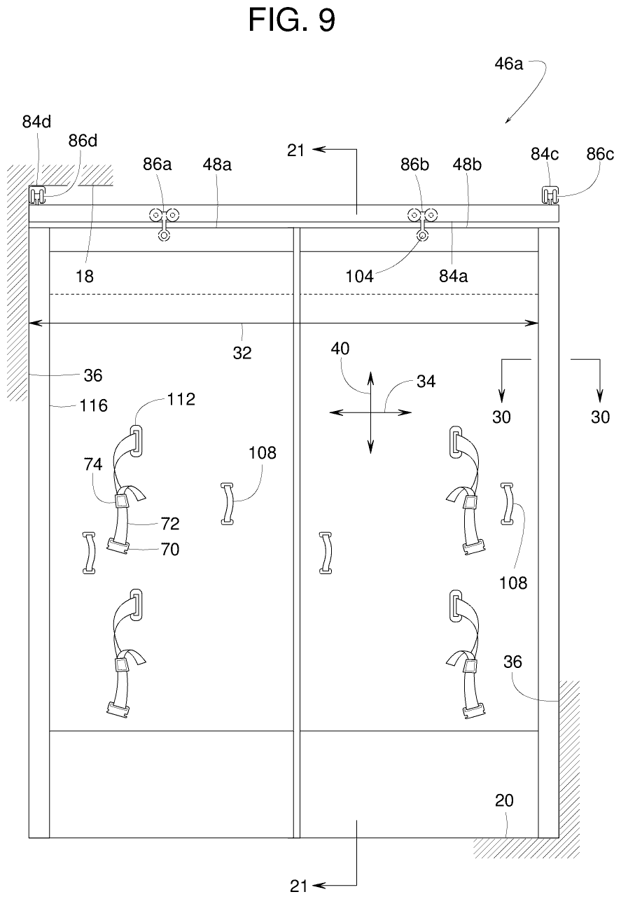

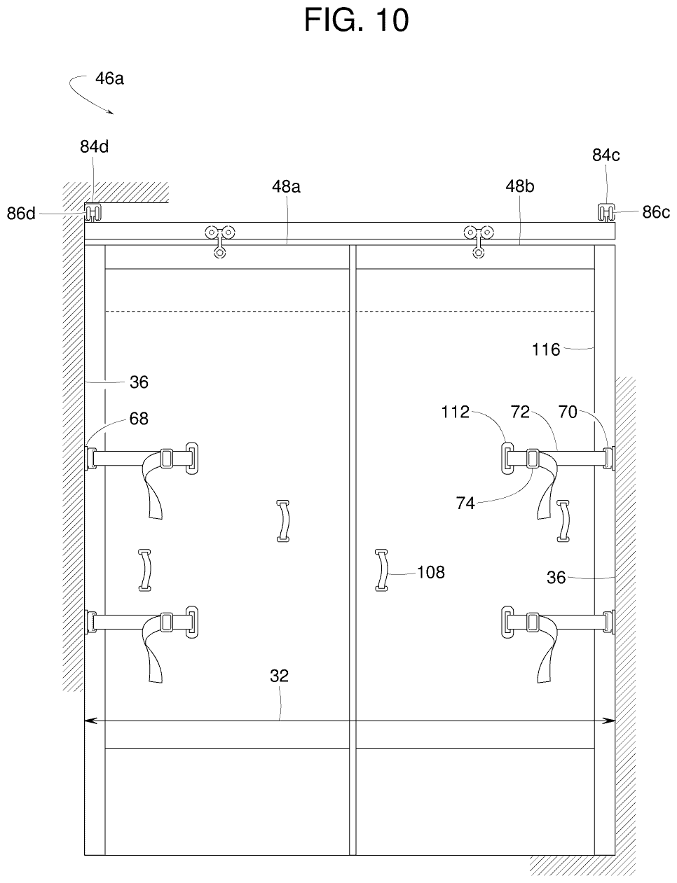

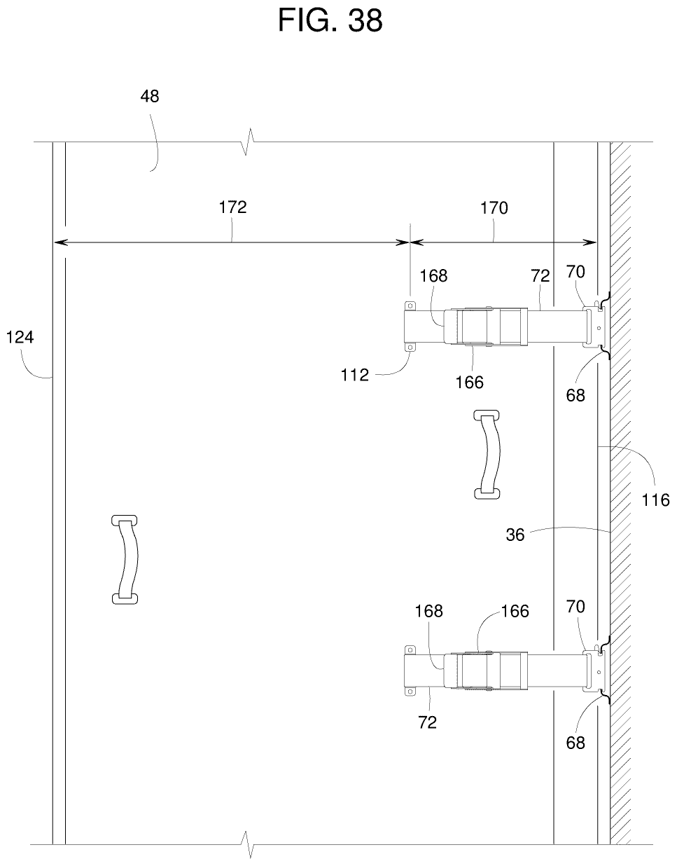

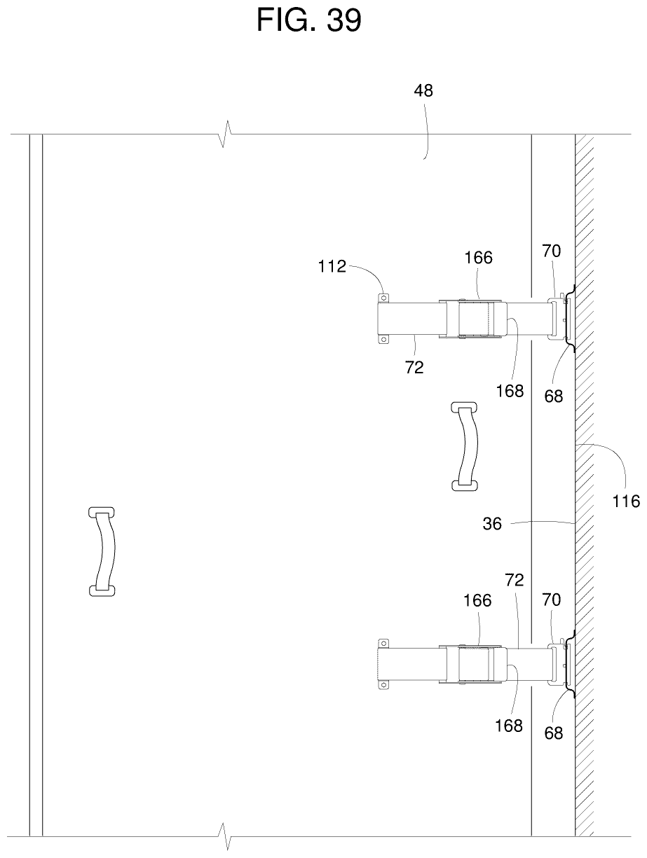

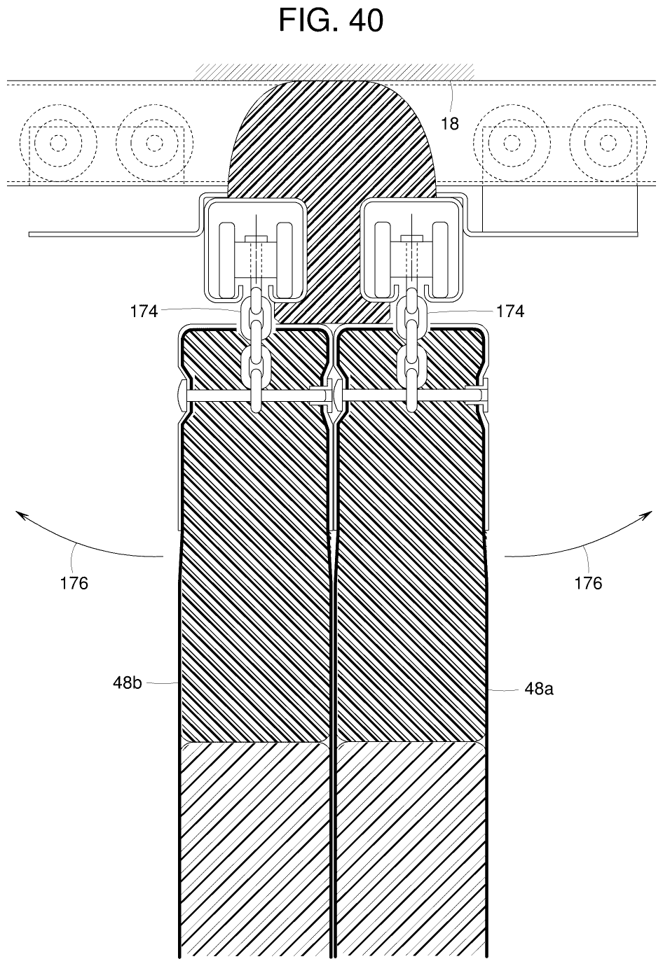

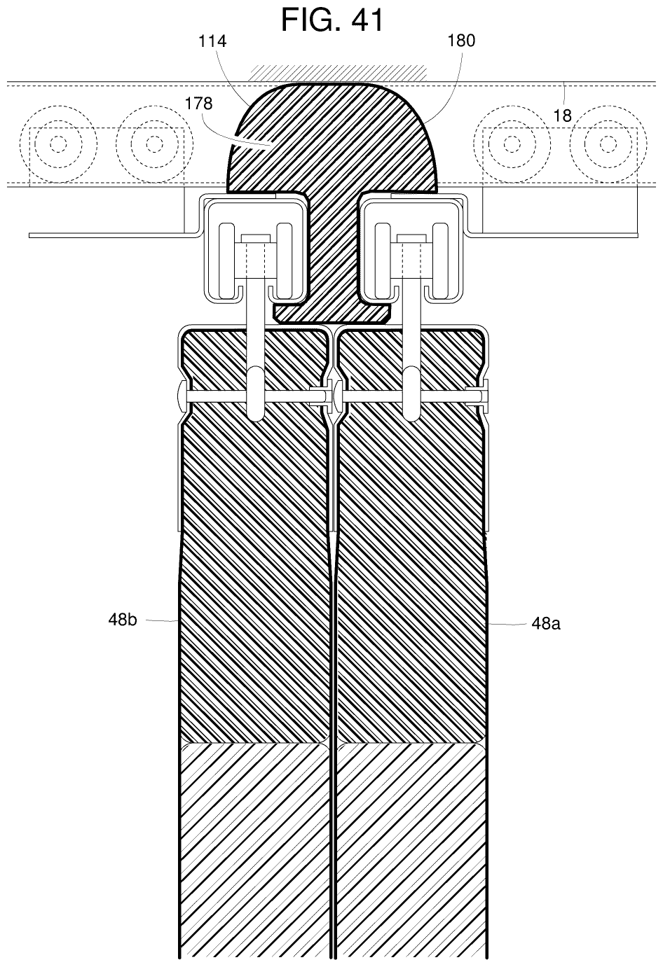

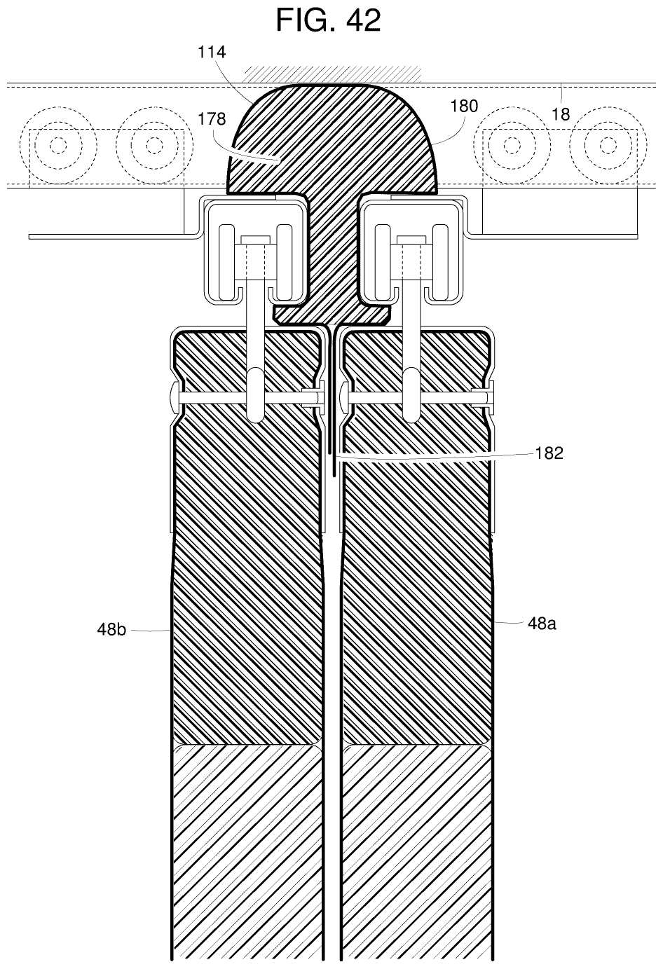

Some examples of straps 72 are tightened and cinched by various hardware such as ratchet mechanisms, cam buckles 74 (e.g., FIGS. 9 and 10), over-center draw latch (FIGS. 38 and 39), double-rings, etc. The term, “strap” refers to any elongate member having a width greater than its thickness and is sufficiently pliable to be folded back over onto itself and later unfolded without causing appreciable permanent damage to the member. The term, “clip” refers to any item or device that can readily latch onto or is otherwise connectable to the logistic track 68. In the example shown in FIGS. 5 and 6, the clip 70 includes an E-track retainer that includes tabs 76 for clipping into slots 78 of the logistic track 68, a spring-loaded release lever 80 for selectively locking and releasing the clip 70, and a slot 82 for connecting to the strap 72.

FIGS. 4 and 7-19 show an overall construction and function of the example bulkhead 46a with the example overhead track system 50a. In the illustrated example, the overhead track system 50a includes a plurality of tracks 84 (e.g., a rear lateral track 84a, a front lateral track 84b, a right longitudinal track 84c, and a left longitudinal track 84d) and a plurality of carriages 86 (e.g., a first carriage 86a, a second carriage 86b, a right carriage 86c, and a left carriage 86d). In some examples, the right longitudinal track 84c and the left longitudinal track 84d can extend in the longitudinal direction 30 and can attach to the ceiling 18 and/or side walls 36 of the cargo transporter 10.

The lateral tracks 84a and 84b extend in the lateral direction 34. The lateral tracks 84a and 84b of the illustrated example are carried or supported by the right carriage 86c and the left carriage 86d. The lateral tracks 84a and 84b can travel along the respective right longitudinal track 84c and the left longitudinal track 84d. The rear lateral track 84a and the front lateral track 84b are substantially parallel and displaced (e.g., out of collinear alignment or spaced apart) relative with each other. For example, the lateral track 84a can be spaced apart from the front lateral track 84b in the longitudinal direction 30. The first carriage 86a can move along the lateral track 84a (e.g., a rear lateral track) and/or can carry or support a weight of the first panel 48a. For example, the first carriage 86a can support a weight of the first panel 48a while the lateral track 84a (e.g., the rear lateral track) guides a lateral movement of the first panel 48a. Likewise, the second carriage 86b travels along the front lateral track 84b and/or can carry or support a weight of the second panel 48b. For example, the second carriage 86b can support the weight of the second panel 48b while the front lateral track 84b guides a lateral movement of the second panel 48b. The carriages 86 can have any number of rollers 88 to achieve a desired load carrying capacity and/or rolling capability. The rollers 88 can be spaced apart any suitable distance to maintain a desired orientation (e.g., perpendicular) relationship between the lateral and longitudinal tracks and reduce (e.g., minimize) binding that can otherwise occur due to non-perpendicularity.

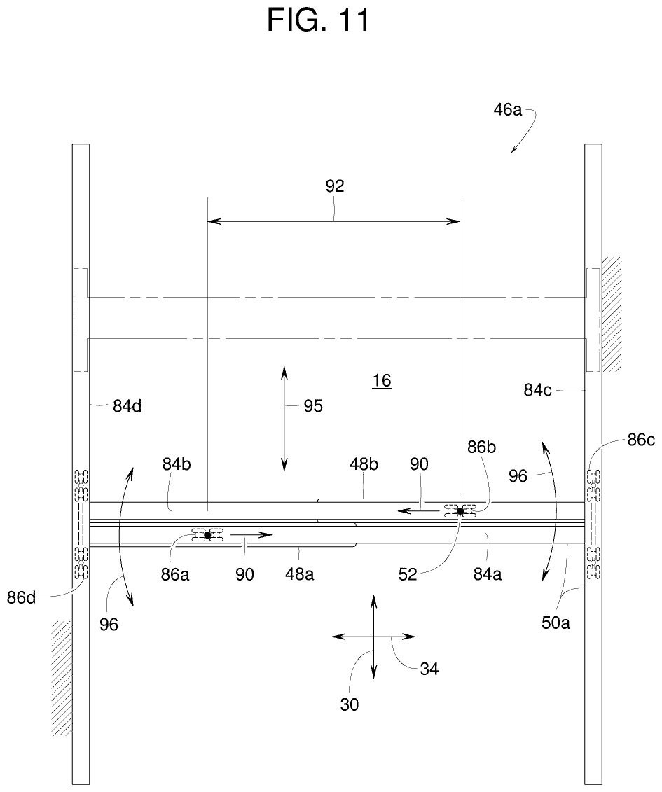

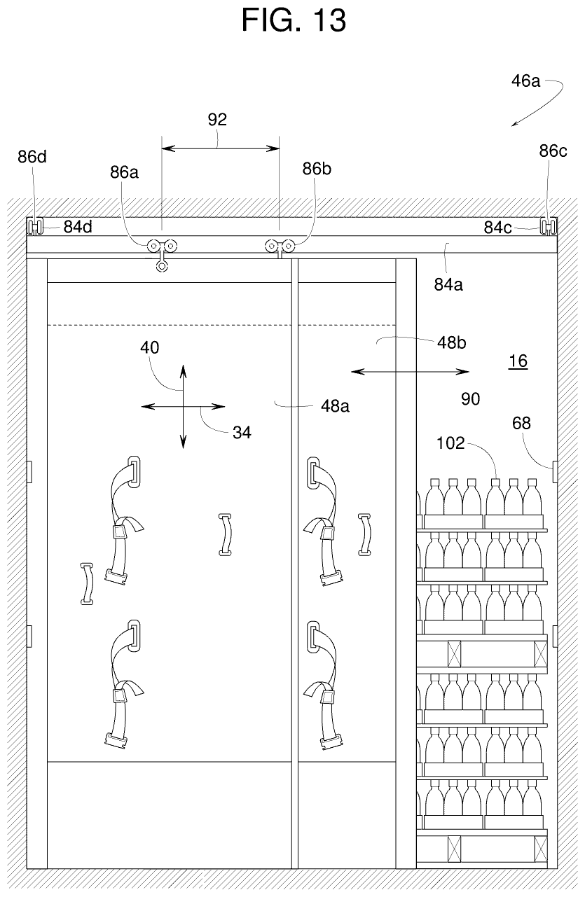

The first and second carriages 86a and 86b allow the relative positions of the first and second panels 48a and 48b to be adjusted laterally and/or independently within cargo storage area 16, as indicated for example by arrows 90 of FIGS. 11 and 13. More specifically, the first carriage 86a of the example shown in FIG. 11 is at a spaced-apart distance 92 from the second carriage 86b. The spaced-apart distance 92 is adjustable (e.g., compare for example the positions of the first carriage 86a and the second carriage 86b in FIGS. 11 and 13) along the overhead track system 50 to vary (e.g., adjust) an extent to which the first panel 48a can overlap the second panel 48b in the lateral direction 34. This allows the bulkhead 46 to move between an open position and a closed position by sliding panel 48a and/or 48b in lateral direction 34 (e.g., side-to-side, or right or left in the orientation of FIGS. 11 and 13).

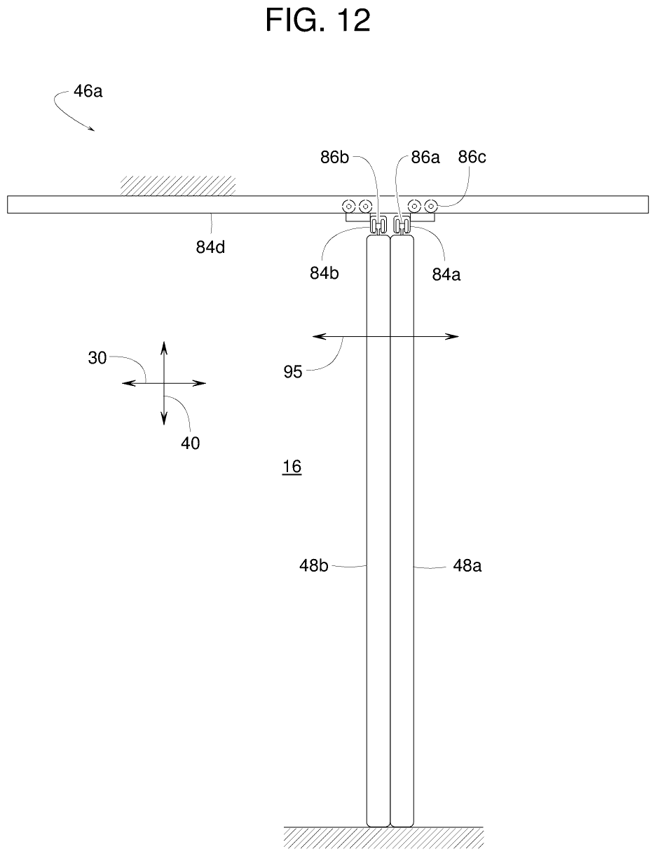

The right and left carriages 86c and 86d of the illustrated example allow the position of the first and second panels 48a and 48b to be adjusted in the longitudinal direction 30 within cargo storage area 16, as indicated for example by arrows 95 of FIGS. 11 and 12. Enabling movement of the panels 48 in the longitudinal direction 30 allows adjusting the size of the different compartments 16a-c in the cargo storage area 16.

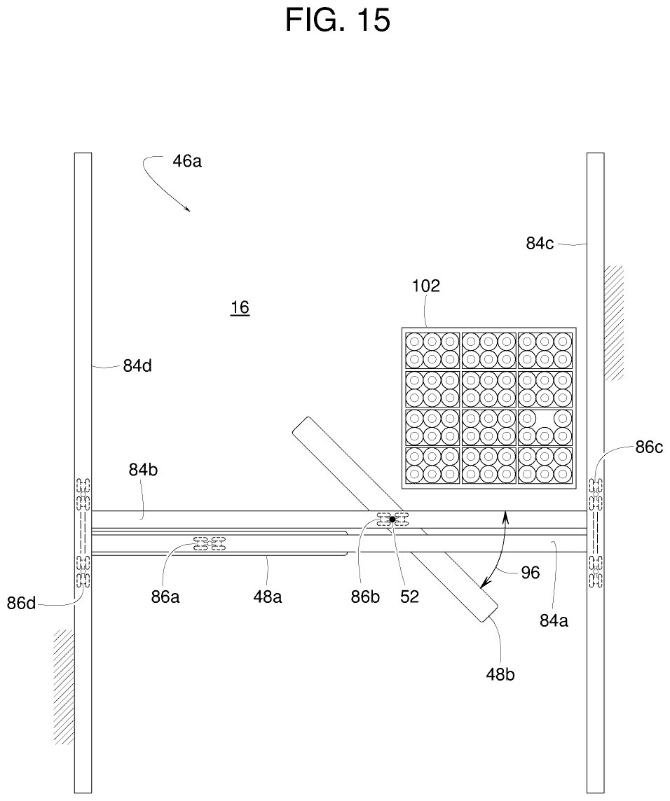

In some examples, the first and second carriages 86a and 86b include a rotatable or twistable swivel joint 94 that enables panels 48 to be (e.g., manually) rotated over a swivel range of motion 96 of between at least 5 degrees and 90 degrees (e.g., 45 degrees) about the axis 52 (see FIGS. 11 and 15). For example, the panels 48 can be rotated to a 45 degree position relative to horizontal to provide an access opening through the bulkhead 46. In some examples, rotation to at least 45 degrees relative to horizontal about the swivel joint 94 may provide a reasonable access opening through the bulkhead 46 The rear lateral track 84a and the front lateral track 84b, the right longitudinal track 84c and the left longitudinal track 84d, and swivel joint 94 enable the panels 48 to be moved laterally, longitudinally and/or rotated, and the overhead track system 50 can support (e.g., a weight of) one or more of the panels 48.

Referring to FIG. 7, each panel 48 includes a cover sheet 98 overlying a core 100 (e.g., a foam core). The core 100 provides each panel 48 with a certain degree of structural stiffness, thermal insulation, and/or weight (e.g., a minimum weight). Some example materials of the core 100 can include expanded polystyrene foam, closed-cell polyethylene, extruded polystyrene foam, and/or various combinations thereof, and/or other suitable material(s).

The cover sheet 98 provides moisture resistance, abrasion resistance, an ability to wash down, and a clean appearance. Some example materials of the cover sheet 98 can include vinyl sheeting, vinyl fabric, polyester sheeting, polyester fabric, and/or any other suitable material(s). In some examples, the cover sheet 98 can weigh about 18 ounces per square-yard. In some examples, the cover sheet 98 can be adhesively and/or thermally bonded to the core 100.

Since at least some of the weight of the panel 48 can be carried by the overhead track system 50, the panel 48 does not necessarily have to be so stiff to support itself (e.g., in an upright orientation). Consequently, the panel 48 can be made of materials that are more flexible and/or more lightweight than conventional bulkhead panels. This can make panels 48 less expensive, more durable, and easier to move in the cargo storage area 16. For example, the panel 48 of the illustrated example includes a core 100 (e.g., a foam core) having a first or lower core section 100a (e.g., a pliable section) and a second or upper core section 100b (e.g., a relatively stiff core section) different than the lower core section 100a.

In some examples, for instance, one or more sections of the core 100 can be made of a lightweight pliable material. The term, “pliable” as it refers to a panel core means that the panel core can be folded back over onto itself and subsequently unfolded without appreciable damage to the panel core. In the example shown in FIG. 7, the panel 48 includes the lower pliable core section 100a. The lower core section 100a can be made of a lightweight pliable material such as polyurethane foam, fiberglass batting, glass wool, polyester batting, aerogel, cryogel, and/or any other suitable material(s). In examples of the panels 48 having one or more pliable core sections 100a, the panels 48 can be (e.g., manually) contorted or manipulated to form a makeshift cargo access opening therethrough or repositioned around preexisting cargo 102 within cargo storage area 16.

In examples where the panel 48 includes the lower pliable core section 100a, the panel 48 includes the relatively stiff upper core section 100b to prevent upper lateral edges of the panel 48 from drooping as a result of the carriage 86 hanging the panel 48 (e.g., from a single central point). The panel 48 of the illustrated example includes the relatively stiff upper core section 100b for increased flexural beam rigidity. The upper core section 100b is relatively or sufficiently stiff to provide a firm structure for anchoring a screw 104. The screw 104 receives or couples to a hanger 106 of carriage 86. Some examples of hanger 106 can include a J-bolt, an eyebolt, a bar, a shaft, etc. Some example materials for the upper core section 100b include expanded polystyrene foam, closed-cell polyethylene, extruded polystyrene foam and/or any other suitable material(s).

Some examples of the panel 48 include one or more handles 108 to facilitate movement of the panels 48 in the cargo storage area 16. The panel 48 of the illustrated example include a header 110 for adding strength and rigidity to the upper edge of the panel 48. The panel 48 of the illustrated example includes straps 72, clips 70 and buckles 74 to secure the panel 48 in position and anchors 112 to connect the straps 72 to the panel 48. In some examples, the panel 48 the header 110, the straps 72, the clips 70, the buckles 74 and/or the anchors 112 can be omitted (see, for example, FIGS. 43-45).

In some examples, header 110 further helps prevent the drooping problem mentioned earlier. In some examples, header 110 is made of a metal (e.g., aluminum), as metal typically is much less susceptible to creep (yielding or drooping after an extended period under load). In some examples, header 110 is made of a metal (e.g., aluminum), plastic, a combination of aluminum and plastic, and/or any other suitable material(s). In some examples, multiple nested headers 110 are used. Some examples include a plastic header over an aluminum one, an aluminum header over a plastic one, and one header thermally welded, screwed, glued, or otherwise attached to core 100.

Some example headers can include other styles and/or variations. For example, some examples headers can include a fiberglass rod and metal, or plastic pipe embedded into a foam panel or captured (e.g., supported) by the fabric covering. In examples where the header is captured by the fabric covering, the cover can support an entire weight of the panel from the header, rather than relying on the core of the panel 48 to carry any weight. The different example headers disclosed herein can be employed when the panels are formed with polyester batting or similar insulating material in place of a foam core.

Some examples of the panel 48 include an upper seal member 114 that may serve multiple functions. Some example functions include sealing between the panel's upper edge 115 and the lateral tracks 84a and 84b, sealing between the trailer's ceiling 18 and the two lateral tracks 84a and 84b, and insulating or at least creating a thermal break between the two lateral tracks 84a and 84b.

Some sealing surfaces of the upper seal member 114 are sliding surfaces (e.g., sliding against ceiling 18 or along the top edge of panel 48) while other sealing surfaces are static (e.g., between the two lateral tracks 84a and 84b). To address these different sealing needs, some examples of upper seal member 114 are made of multiple materials by way of various processes known as co-extruding, over-molding, co-molding, double injection molding, and/or any other suitable manufacturing process(es). Additionally, some example materials of upper seal member 114 can include closed cell polyurethane foam, neoprene, urethane, and/or various combinations thereof, and/or any other suitable material(s). Some example materials of header 110 can include high density polyethylene, rigid vinyl, etc.

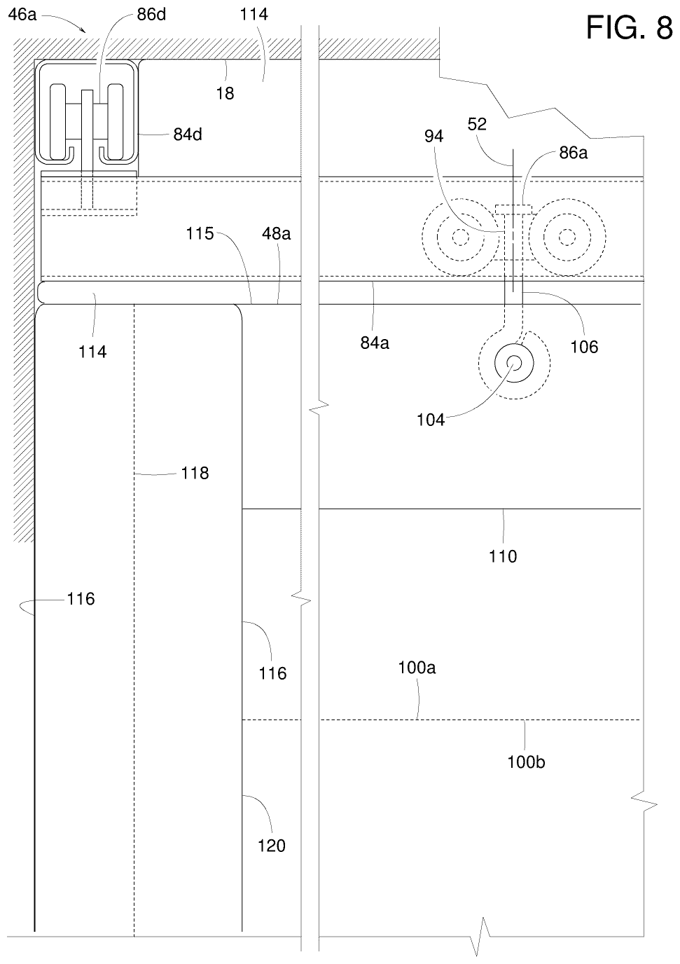

The panel 48 of the illustrated example includes a side seal 116 (FIGS. 8-10) to seal against the side walls 36. The side seals 116 include a soft, pliable foam core 118 covered by a protective flexible outer cover 120 (e.g., a sheet of material). To effectively seal around the logistic tracks 68 and other possible irregularities of the side walls 36, the foam core 118 of the side seal 116, in some examples, is softer and/or more compliant than the core 100 of the panel 48 (e.g., the upper core section 100b).

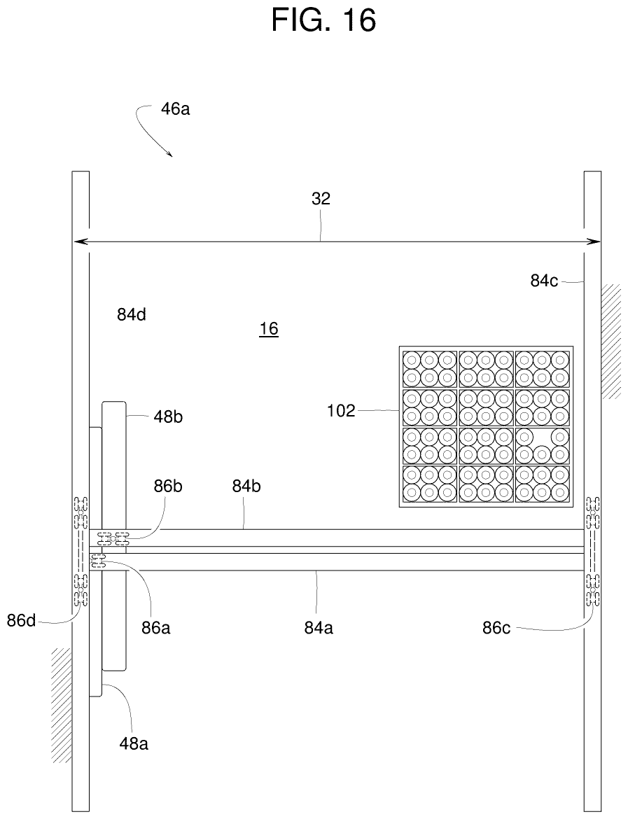

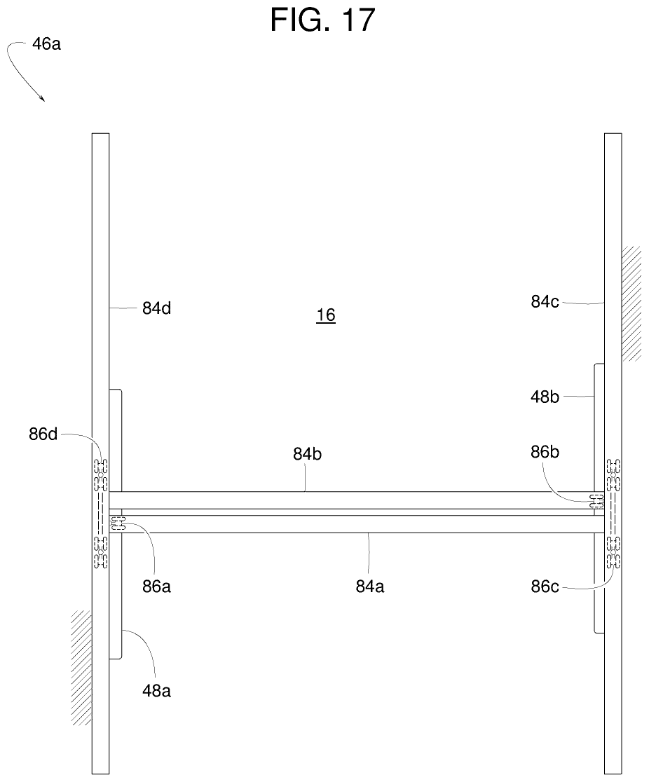

In some example sequences of operation, a worker can move the panels 48 aside (e.g., toward, or adjacent the side walls 36) so the panels 48 do not interfere with loading the trailer 12 with cargo 102. For example, the panels 48a and 48b can be rotated so a front face or a longitudinal width of the panels 48a and/or 48b are generally parallel to the trailer's side walls 36. For example, the panels 48a and 48b can be moved to one side of the trailer 12, as shown in FIG. 16. Alternatively, the panels 48a and 48b can be placed at opposite sides, as shown in FIG. 17. In other words, the panel 48a can be positioned adjacent a first one of the side walls 36 and the panel 48b can be positioned adjacent a second one of the side walls 36. In some examples, the straps 72 and logistic tracks 68 secure the panels 48 to the side walls 36 of the trailer 12.

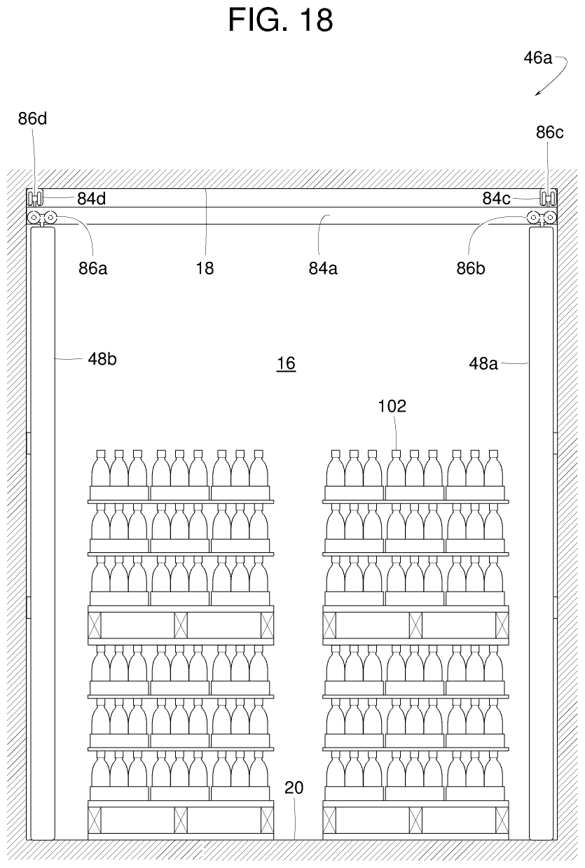

After cargo 102 is loaded onto the trailer 12 (e.g., as shown in FIGS. 16 and 18), the panels 48 can be moved back over to span the width 32 of the trailer 12 and moved forward up against or near the cargo 102, so the cargo 102 is contained in a reasonably sized section of the cargo storage area 16. After the panels 48 are properly positioned, the clips 70 of the straps 72 are latched onto the logistic tracks 68. To secure the panels 48 and to press the side seals 116 against the side walls 36, the straps 72 are pulled tight and locked in place by the buckles 74, as shown in FIG. 10. At this point, the trailer 12 is ready for delivering the cargo 102 to one or more desired locations.

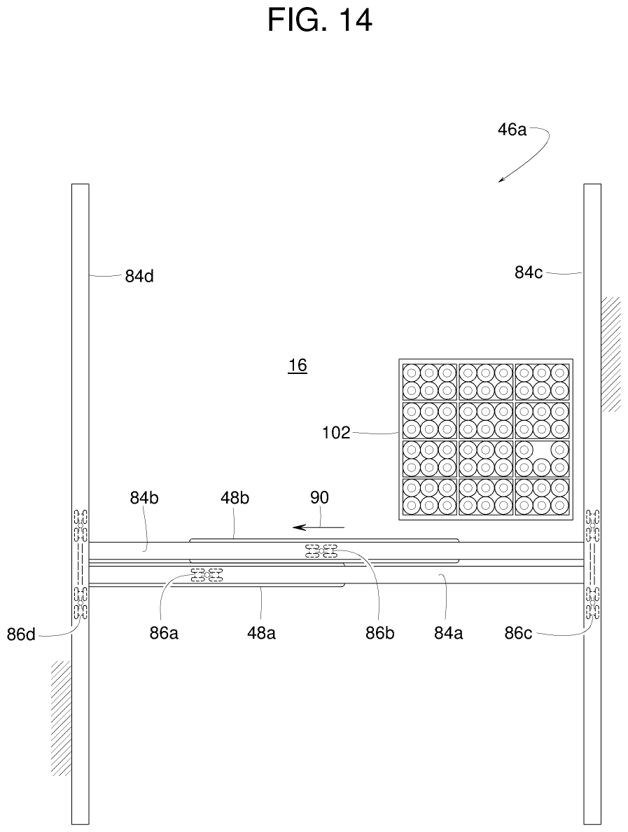

At a desired delivery location, the cargo 102 can be removed from the cargo storage area 16 through one of the side doors 44. Alternatively, some or all of the cargo 102 can be accessed by releasing the straps 72 and moving one or more of the bulkheads 46 to an open position. The bulkheads 46 can be moved to respective open positions by moving the panel 48a and/or the panel 48b laterally (e.g., as shown in FIGS. 13 and 14) or by swinging the panel 48a and/or the panel 48b about the axis 52 (e.g., as shown in FIG. 15).

Some additional features or options for the bulkheads 46 are shown in FIGS. 19-22. Referring to the top views of FIGS. 19 and 20, to improve the sealing engagement between the panels 48a and 48b, some example bulkheads 46 include strip magnets 122 extending along adjacent edges 124 (e.g., vertical edges) of the panels 48. The strip magnets 122 of the illustrated example are contained by flexible material 126 to accommodate or adjust (e.g., align) misalignment between the panels 48a and 48b.

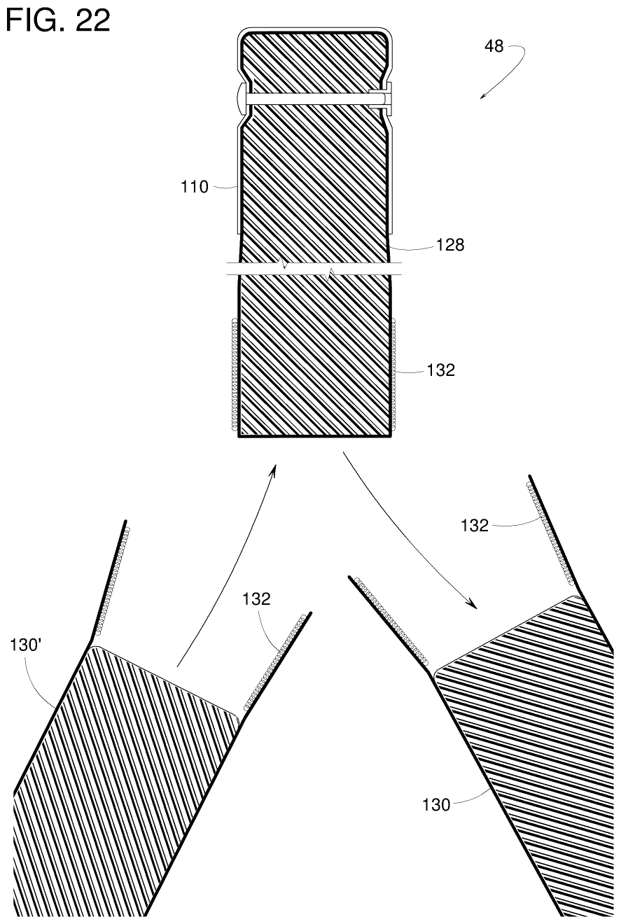

Referring to FIGS. 21 and 22, the panels 48 include an upper section 128 and a replaceable lower section 130 with a restorable disconnectable joint 132 connecting the upper section 128 and the lower section 130. The restorable disconnectable joint 132 enables replacement of the lower section 130, which may be a benefit, as the lower section 130 of a panel can often be subject to the most wear and tear. Some examples of the restorable disconnectable joint 132 include, but are not limited to, a zipper, a series of snaps, touch-and-hold fastener (e.g., a hook-and-loop fastener, VELCRO, interlocking matrix of mushroom heads, etc.) and/or any other fastener(s). In some examples, the restorable disconnectable joint 132 can be positioned at an elevation such that a lower section height 134 of replaceable lower section 130 is between about 20-50% of an upper section height 136 of the upper section 128. In some instances, a lower section 130 that is less than 20% of the upper section height 135 may fail to cover a portion of the panel 48 most susceptible to damage. In some instances, a lower section 130 that is greater than 50% of the upper section height 135 can cause the panel 48 may become overly rigid and/or heavy. However, in some instances, the lower section 130 can be configured to be less than 20% and/or greater than 50% of the upper section height 135.

FIG. 21 shows the upper and lower sections 128 and 130 having a foam core 136. In the illustrated example, the foam core 136 of upper section 128 is encased by the cover sheet 98. The replaceable lower section 130, in some examples, includes a cover sheet 138 that is more durable than the cover sheet 98. Some examples of the cover sheet 138 include, but are not limited to, relatively heavy vinyl fabrics, KEVLAR, high molecular weight polyethylene, high density polyethylene, conveyor belt material, Durathon® friction-resistant fabric, and/or any other suitable material(s). FIG. 22 shows a worn lower section 130 replaced by a non-worn lower section 130′.

In some examples, the panels 48 can be configured with a one-piece core encased with the cover sheet 98. To provide wear resistance to the panels 48, the panels 48 can include a friction-resistant material (e.g., Durathon®) to cover at least a wear area of the panels 48. For example, a lower portion of the panels 48 can include a layer (e.g., a strip having between 2 inches and 10 inches in height) of the friction-resistant fabric. In this manner, the friction-resistant fabric hangs on a front and/or back surface of the panels 48. For example, the friction-resistant fabric can couple to the panel 48 (e.g., an outer surface of the cover sheet 98) can removably couple to a surface (e.g., an outer surface) of the sheet 98 via a fastener (e.g., a zipper, a series of snaps, touch-and-hold fastener (e.g., a hook-and-loop fastener, VELCRO, interlocking matrix of mushroom heads, etc.). For example, the fastener can be positioned on an upper edge of the friction-resistant fabric. The friction-resistant fabric can be removed from the sheet 98 (e.g., a cover) when worn and replaced with a new friction-resistant fabric.

FIGS. 23-27 show another example bulkhead 46b disclosed herein. The bulkhead 46b can be implemented with an example overhead track system 50b. Those components of the bulkhead 46b and/or the overhead track system 50b of FIGS. 23-27 that are substantially similar or identical to the components of the bulkhead 46a and/or the track overhead system 50a of FIGS. 1-22 described above and that have functions substantially similar or identical to the functions of those components will not be described in detail again below. Instead, the interested reader is referred to the above corresponding descriptions. To facilitate this process, similar reference numbers will be used for like structures.

The overhead track system 50b includes a right longitudinal track 84c and a left longitudinal track 84d. Instead of the rear lateral track 84a and the front lateral track 84b, however, the overhead track system 50b includes a single common lateral track 84f that carries panels 48a and 48b.

The common lateral track 84f is connected to the right carriage 86c and the left carriage 86d. The common lateral track 84f moves along the respective right longitudinal track 84c and the left longitudinal track 84d. The first carriage 86a of the first panel 48a and the second carriage 86b of the second panel 48b are mounted for movement in a substantially linear path along the common lateral track 84f.

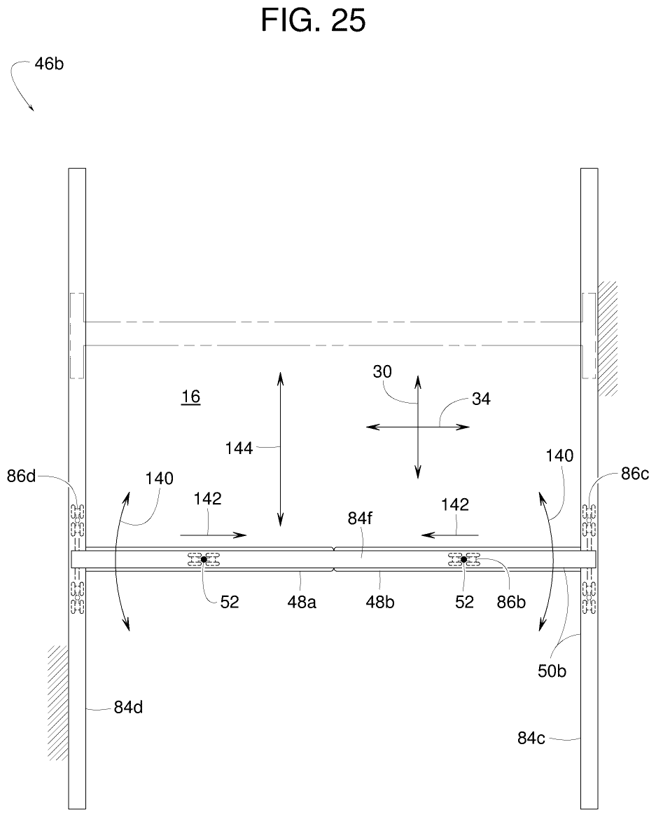

A swivel joint 94 of each of the first carriage 86a and the second carriage 86b enables the panels 48 to be (e.g., manually) rotated (e.g., at least 45 degrees) about an axis 52 (e.g., a vertical axis as indicated by arrows 140 of FIG. 25). The common lateral track 84f and the first and second carriages 86a and 86b allow the panels 48 to move laterally (e.g., as indicated by arrows 142 of FIG. 25). The right longitudinal track 84c and the left longitudinal track 84d and/or the right carriage 86c and the left carriage 86d allow the panels 48 to move longitudinally (e.g., as indicated by arrow 144 of FIG. 25). So, the panels 48 can be moved laterally, longitudinally and/or rotated, while at least some of a weight of at least one of the panels 48a, 48b is supported by the overhead track system 50b.

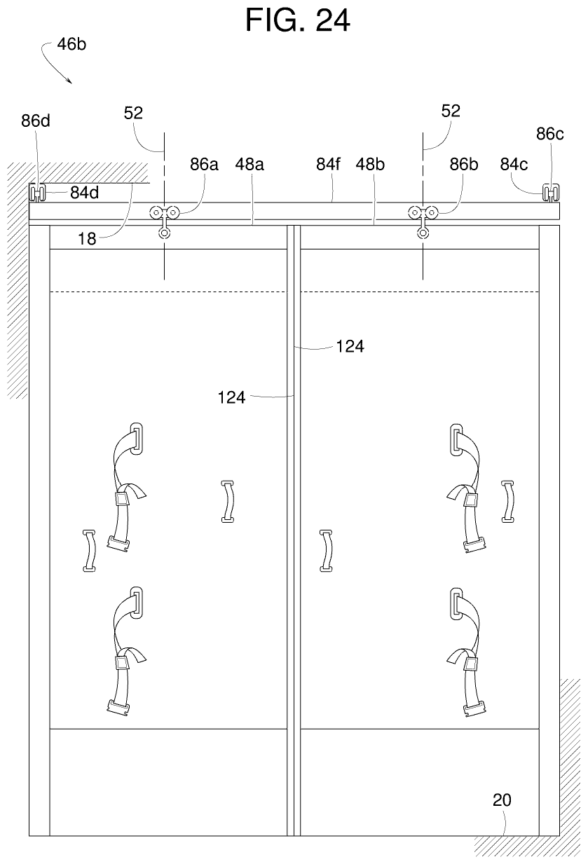

When the bulkhead 46b is in a generally closed configuration, as shown in FIGS. 24 and 25, abutting inner edges 124 of the panels 48 seal against each other. In some examples, the abutting inner edges 124 include the strip magnet 122 (e.g., as shown in FIG. 20). In addition, or alternatively, the abutting inner edges 124 include a seal similar to side seals 116.

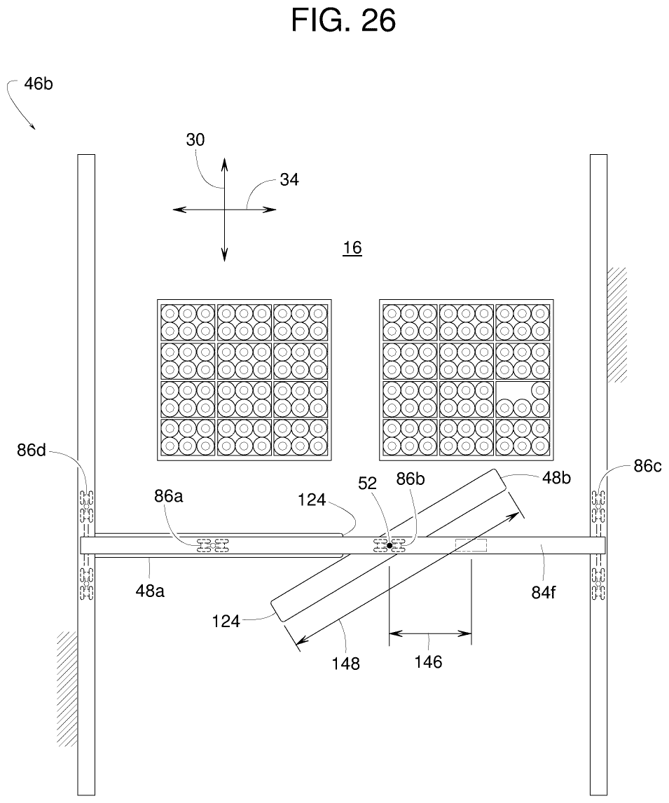

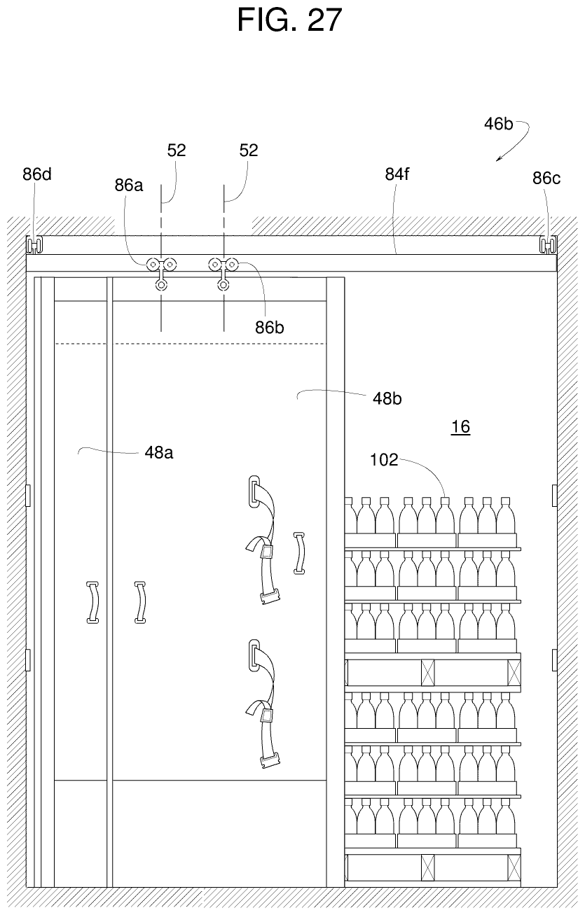

When loading or unloading of cargo 102, the panels 48 can be rotated and moved laterally off to the side in an arrangement similar to that shown in FIGS. 16-18. In some examples, to access the cargo 102, the panels 48 can be (e.g., slightly) rotated and/or moved laterally (e.g., as shown in FIGS. 26 and 27). In some examples, the panels 48 are designed so that the first and second carriages 86a or 86b (e.g., lateral carriages) can be move in the lateral direction 34 over a lateral travel distance 146 that is greater than at least one third of the panel's width 148 (e.g., as shown in FIGS. 26 and 27). Moving the panels 48 in the lateral direction 34 over a lateral travel distance 146 provides an (e.g., a sufficient) access opening for the bulkhead 46 to allow removal of goods.

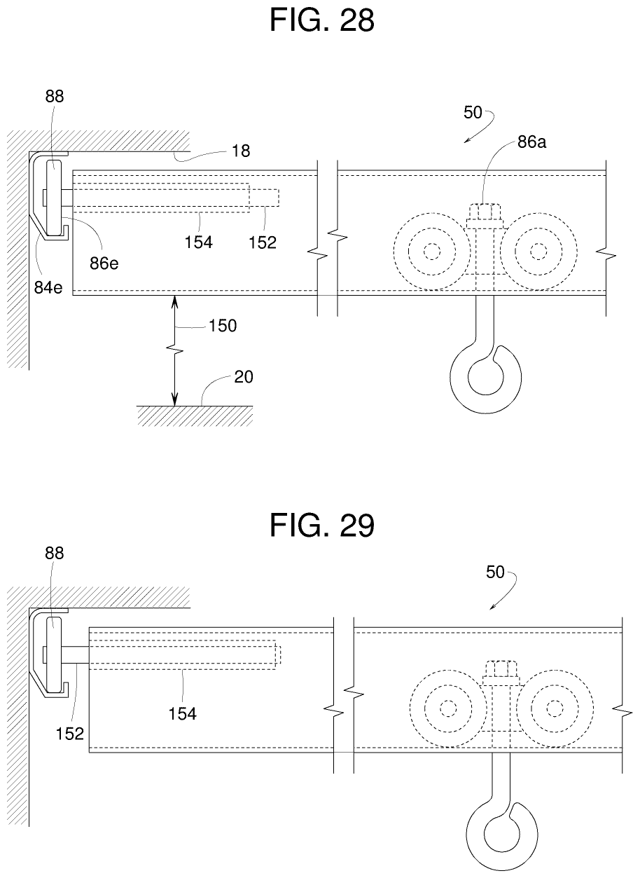

FIGS. 28 and 29 show an optional modification to the bulkheads 46a and 46b that provides a greater track head clearance 150 and can reduce (e.g., minimize possible) track binding as the panels 48 move in the longitudinal direction 30. In this example, the right and/or left carriages 86c and 86d are replaced by an axially floating carriage 86e, and alternate longitudinal tracks 84e replace the right longitudinal track 84c and the left longitudinal track 84d. An axle 152 of roller 88 slides within an axle-supporting sleeve 154 that is attached to the lateral tracks 84a and 84b or to common lateral track 84f. The sliding connection (e.g., fit) between the axle 152 and the sleeve 154 allows the roller 88 to (e.g., easily) follow the longitudinal track 84e even if the longitudinal track 84e becomes out-of-square or if the longitudinal tracks 84e are not perfectly parallel relative to each other.

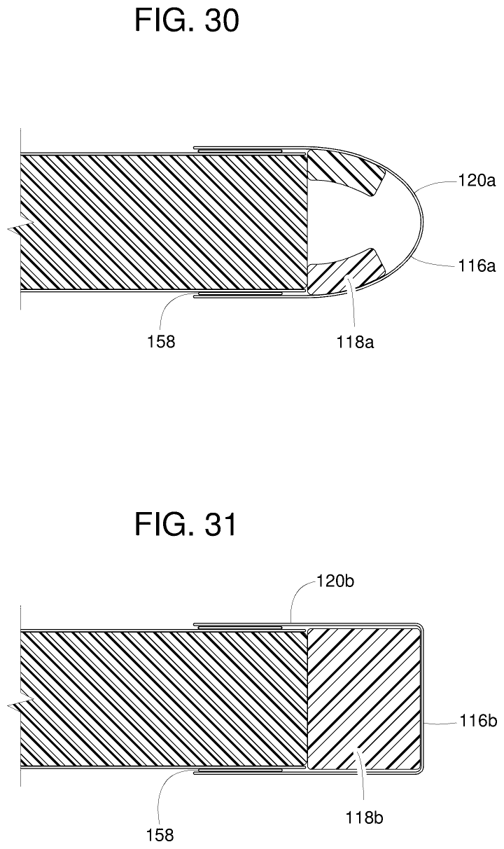

FIGS. 30-32, 33A and 33B show various examples of the side seal 116 (e.g., side seals 116a, 116b, 116c, 116d and 116e). Each of the example side seals 116 include the soft foam core 118 (e.g., foam cores 118a, 118b, 118c, 118d and 118e) protected by flexible outer cover 120 (e.g., outer covers 120a, 120b, 120c, 120d and 120e). Some examples of outer cover 120 include flexible lips of material 156 for better sealing around logistic tracks 68 and/or other irregularities of the side walls 36. The flexible outer cover 120 can be attached to sheet 98 of the panel 48 via, for example, sewing, adhesive bonding, thermal bonding, a touch-and-hold fastener 158, and/or any other suitable fastener(s).

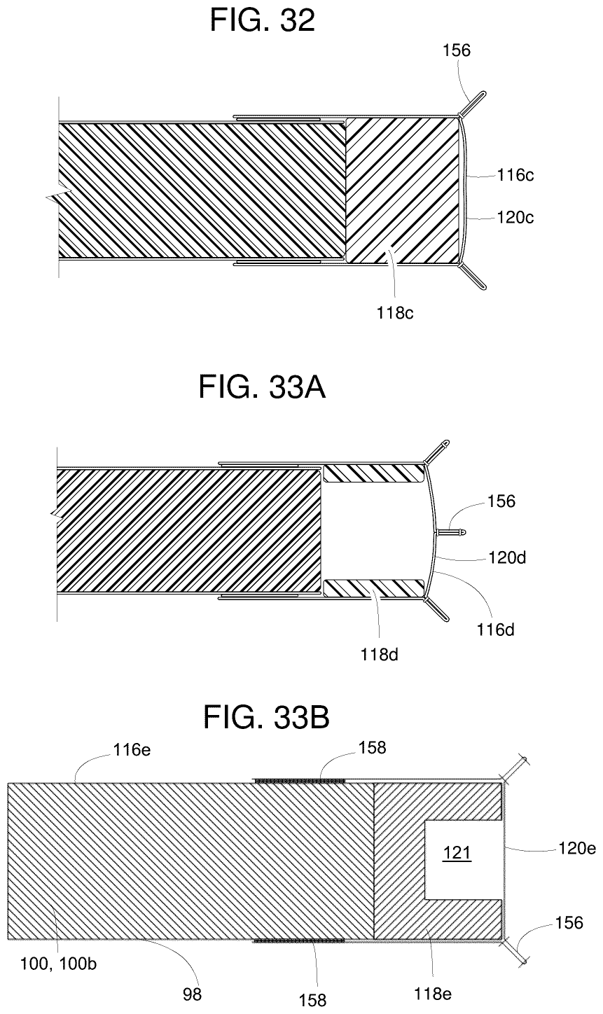

Referring to FIG. 33B, the side seal 116e includes a soft foam core 118e coupled to the core 100 (e.g., the upper core section 100b). In the illustrated example, the soft foam core 118e has a soft core cover 120e (e.g., that encases the soft foam core 118e). The soft core cover 120e couples to the sheet 98 (e.g., an 18-oz vinyl cover) of the core 100 (e.g., via the touch-and-hold fasteners 158). In some examples, the soft foam core 118e can couple to the core 100 via adhesive (e.g., glue), heat seal, and/or other suitable fastener(s). In the illustrated example, the soft foam core 118e has material removed to define a void or cavity 121. For example, the soft foam core 118e of the illustrated example has a U-shape cross-sectional shape. The soft foam core 118e provides improved compressibility compared to seals with a solid block of low density open cell foam. The soft foam core 118e can be configured to provide different compressibility characteristics by adjusting (e.g., increasing or decreasing) a size of the void. For example, a larger sized void (e.g., the greater an amount of material removed) increases a compressibility characteristic of the soft foam core 118e. For example, a smaller sized void (e.g., the smaller an amount of material removed) reduces a compressibility characteristic of the soft foam core 118e. Thus, the example soft foam core 118e can provide greater amount of control of the compressibility characteristics of the seal foam core 118e compared to seals with a solid block of low density open cell foam. The example seal foam core 118e provides a less expensive alternative to using foam densities that are not readily available.

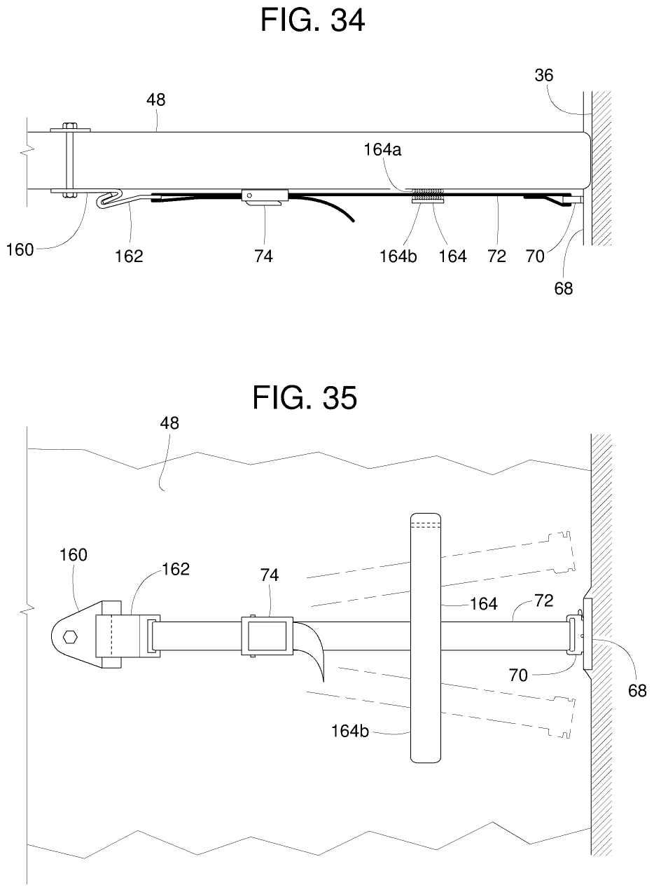

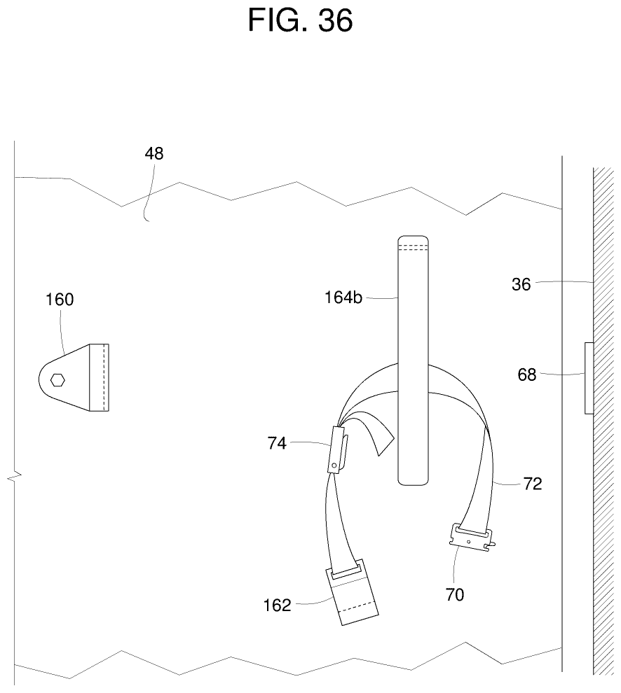

FIGS. 34-37 show an optional breakaway strap design. The illustrated example includes strap 72, buckle 74, clip 70, an anchor plate 160, an anchor hook 162, and a breakaway loop 164. When strap 72 is coupled to and holding panel 48 in position, as shown in FIGS. 34 and 35, clip 70 is latched onto logistic track 68, anchor hook 162 is hooked onto anchor plate 160, and strap 72 is pulled tight. Tension in strap 72 holds anchor hook 162 in tight engagement with anchor plate 160.

Breakaway loop 164 includes two vertically elongate mating strips 164a and 164b of a touch-and-hold fastener. A first strip 164a is coupled to panel 48. For example, the first strip 164a can be sewn, thermally bonded, adhesively bonded, and/or otherwise permanently attached to the panel 48. An upper end of the mating strip 164b can be permanently attached to the first strip 164a. Strap 72 can be sandwiched between strips 164a and 164b at a height that is adjustable (as indicated by arrow 165) to match an elevation of logistic track 68. When tightening or loosening strap 72, the strap 72 can readily slide lengthwise between strips 164a and 164b because strap 72 has neither a hook nor a loop structure. In other words, the strap 72 can slide within the breakaway loop 164 between a first end (e.g., an upper end) of the breakaway loop 164 and a second end (e.g., a lower end) of the breakaway loop 164.

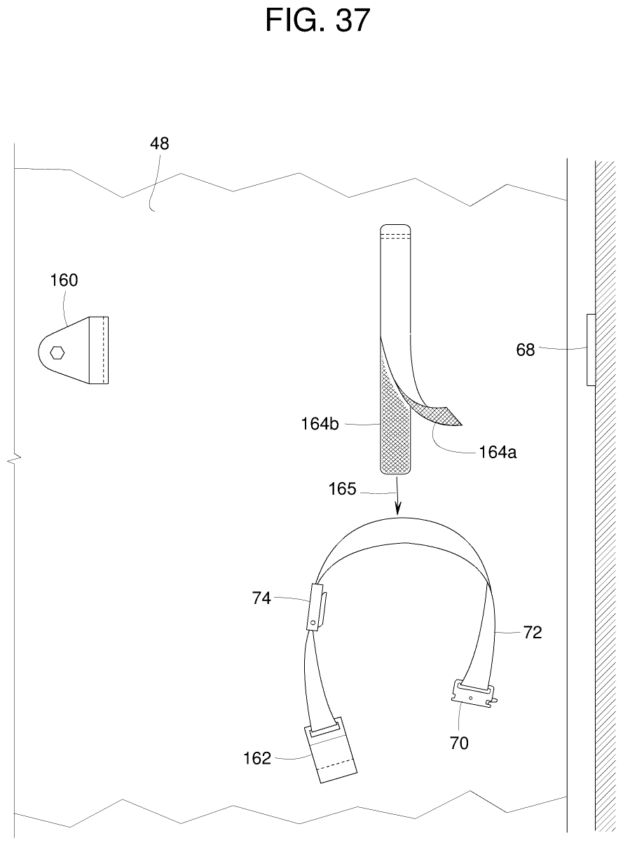

To release the panel 48, buckle 74 is opened and clip 70 is unlatched from logistic track 68 in a conventional manner. As the tension in strap 72 is released, anchor hook 162 moves away (e.g., naturally falls via gravity) away from anchor plate 160. The strap 72 can hang or remain suspended from breakaway loop 164, as shown for example in FIG. 36. To prevent damage to the strap 72, strips 164a and 164b at least partially separate to release strap 72 as shown, for example, in FIG. 37. For example, if an operator or fork truck accidentally snags and forcibly yanks or pulls the strap 72 from the panel 48, the strips 164a and 164b at least partially separate to release the strap 72.

In some examples, the breakaway feature of strap 72 can be accomplished using various restorable disconnectable fasteners. Examples of such fasteners include snaps, VELCRO, magnets, resiliently releasable hooks, and connectors and/or any other fastener(s).

In the example shown in FIGS. 38 and 39, panel 48 includes a buckle 166. The buckle 166 of the illustrated example is an over-center draw latch. Buckle 166 provides a predefined degree of strap tightness or tension. FIG. 38 shows a lever 168 of buckle 166 in a loosened position where side seal 116 is spaced apart or touching (e.g., in a non-compressed state) the side wall 36. FIG. 39 shows the buckle's lever 168 in a tightened position forcing side seal 116 firmly against side wall 36 (e.g., to cause the side seal 116 to compress). Moving lever 168 from a loosened position (FIG. 38) to a tightened position (FIG. 39) changes the distance between anchor 112 and clip 70 by a consistent predefined distance (e.g., a ½ inch or ¾ inches). This ensures that side seal 116 is properly and evenly pressed sealingly (e.g., compressed) against the side wall 36, without over or under tightening strap 72.

In some examples, anchors 112 are positioned closer to the side seal 116 than to the inner edge 124. More specifically, distance 170 of FIG. 38 is less than distance 172. Thus, strap 72 pulls, rather than pushes, most of panel 48 toward the side wall 36. This can be a particularly important feature in examples where panel 48 has a pliable inner core, as a relatively soft core might not have the compressive strength or rigidity to be pushed against side wall 36.

In the example shown in FIG. 40, a flexible hanger 174 is coupled to the panels 48a and 48b. For example, the flexible hanger 174 provides greater flexibility characteristics than the hanger 106. The flexible hanger 174 allows panels 48a and 48b swing in an upward direction 176 toward the ceiling 18. In some examples, the panels 48a and 48b can be stored against the ceiling 18 when not in use. Panels 48a and 48b can be swung in opposite, upward directions 176, as shown for example in FIG. 40, or swung upward in the same direction (e.g., due to the panel's pliability and/or being laterally offset to each other). Examples of the flexible hanger 174 include a chain, a cable, a strap, a hinge, a linkage, and/or various combinations thereof, etc.

In some examples, as shown for example in FIGS. 41 and 42, upper seal member 114 includes a soft foam core 178 (e.g., open cell, closed cell, low density foam, soft rubber, etc.) encased within a low friction, a wear resistant cover 180 (e.g., vinyl coated fabric). In the example shown in FIG. 42, cover 180 includes one or more flaps 182 hanging down between panels 48a and 48b. Flaps 182 can help seal or block off the area between panels 48a and 48b.

FIG. 43 is a perspective view of another example bulkhead 46c disclosed herein. The bulkhead 46c of the illustrated example can be suspended from the example overhead track system 50 to divide the cargo storage area 16 of the vehicle into separate compartments 16a-c (FIG. 4). For example, the bulkhead 46c includes a thermally insulated panel 48c that can be suspended from the example overhead track system 50 via, for example, the swivel joint 94 (FIG. 8). For example, like the panels 48 (e.g., the first panel 48a, the second panel 48b), the panel 48c includes a cover sheet 98 (FIG. 7) overlying the core 100 (FIG. 7). The core 100 provides the panel 48c with a certain degree of structural stiffness, thermal insulation, and/or weight (e.g., a minimum weight).

The panel 48c of the illustrated example can be used to implement the bulkhead 46 of FIGS. 1-42 instead of the panels 48a and 48b. For example, the panel 48c of the illustrated example can be used instead of the panels 48a and 48b. In some examples, the panel 48c of the illustrated example can replace the panel 48a and be used in conjunction with the panel 48b. In some examples, the panel 48c of the illustrated example can be replace the panel 48b and be used in conjunction with the panel 48a.

To secure the panel 48c to the side wall 36 of the trailer 12, the panel 48c of the illustrated example includes a restraint 300. Specifically, the restraint 300 of the illustrated example interfaces with the logistic tracks 68 (e.g., the upper logistic track 68a and/or the lower logistic track 68b) of the trailer 12 to retain or store the panel 48c within the trailer 12 when the panel 48c is not in use. For example, as shown in FIG. 4, the logistic tracks 68 are located on the side walls 36 (e.g., the left and/or right side walls) of trailer 12. In some instances, one or more logistic tracks 68 can be located on the front lateral wall of the trailer 12.

The restraint 300 of the illustrated example includes a first restraint 302 and a second restraint 304. The first restraint 302 and the second restraint 304 are located on a first surface 306 (e.g., an inner surface) of the panel 48c. Additionally, the first restraint 302 and the second restraint 304 interface and/or interact with an upper logistic track 68a. For example, the first restraint 302 and the second restraint 304 of the illustrated example are aligned with the upper logistic track 68a. For example, the first restraint 302 and the second restraint 304 are spaced laterally along a common line 308 and are positioned at an elevation from a lower edge 310 of the panel 48c that is similar (e.g., identical) to an elevation of the upper logistic track 68a. However, in some examples, the panel 48c can include one restraint (e.g., the first restraint 302) or more than two restraints (e.g., three restraints, five restraints, etc.). In some examples, the panel 48c can include one or more restraints 300 that align with and/or interface with a lower logistic track 68b. In some examples, the panel 48c can include one or more restraints 300 to interface with the upper logistic track 68a and/or one or more restraints 300 to interface with the lower logistic track 68b.

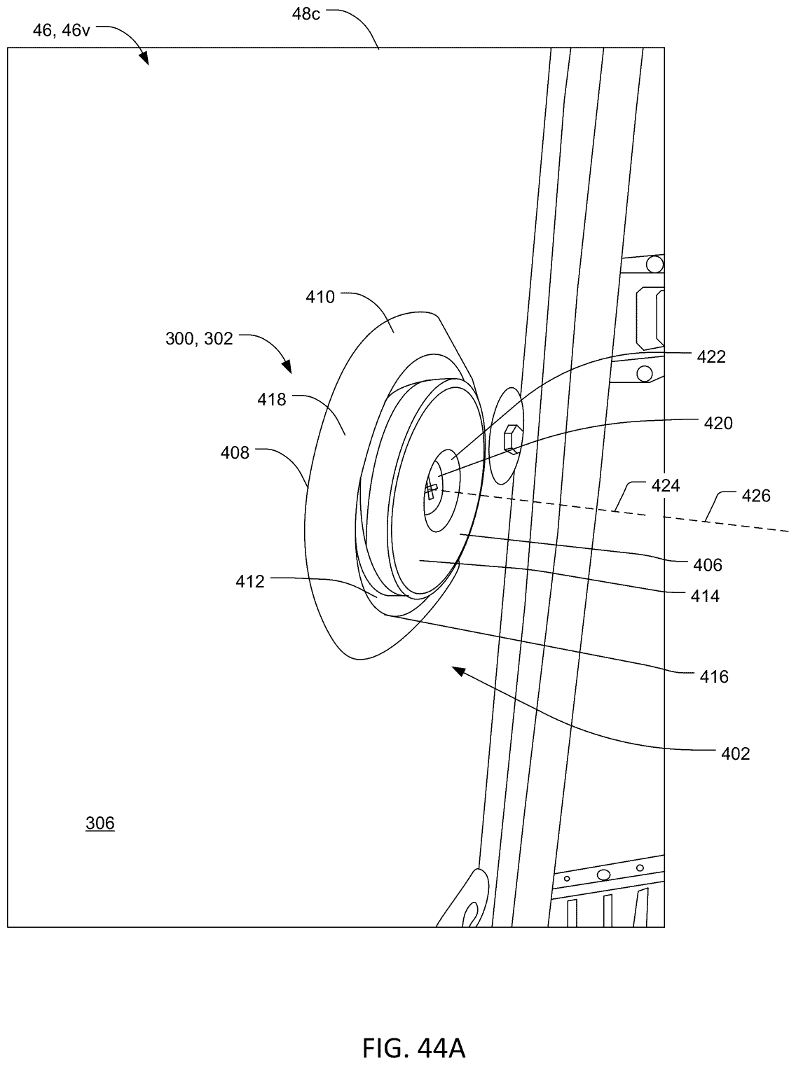

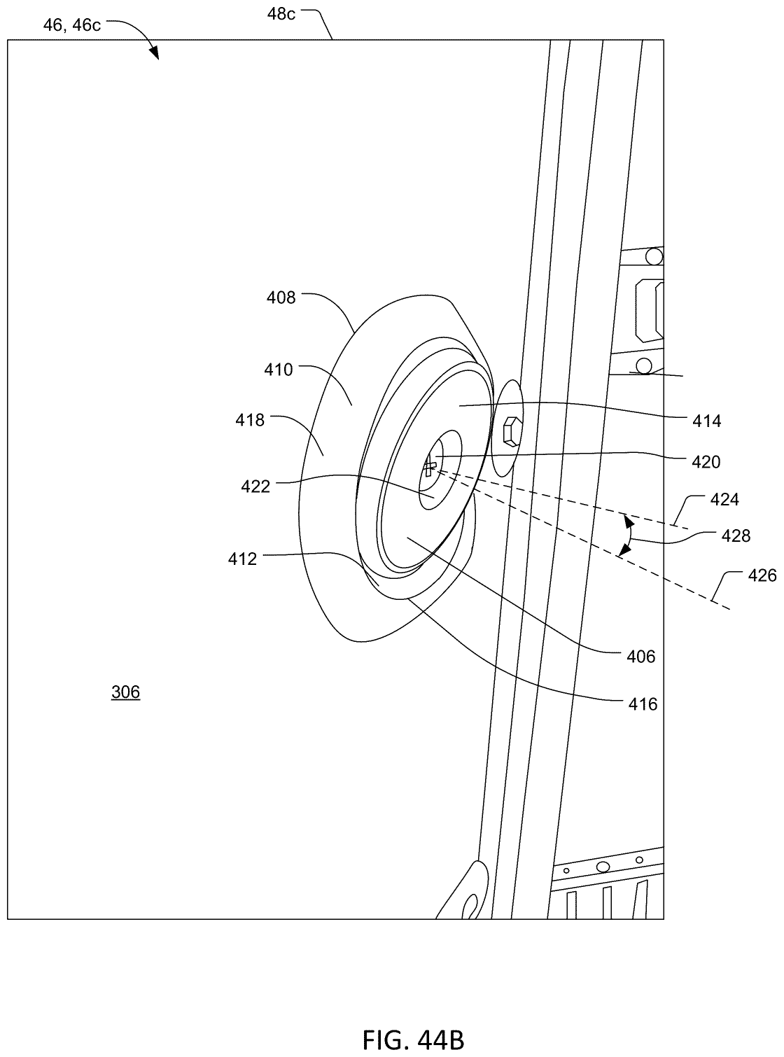

FIG. 44A is an enlarged view of the example restraint 300 of FIG. 43 shown in a first position 402. FIG. 44B is an enlarged view of the example restraint 300 shown in a second position 404. Referring to FIGS. 44A and 44B, the restraint 300 of the illustrated example includes a magnet 406. The magnet 406 of the illustrated example is coupled to the panel 48c via a housing 408. For example, the magnet 406 is positioned at least partially within the housing 408. The magnet 406 and the housing 408 of the illustrated example are carried by the panel 48c.

The housing 408 of the illustrated protrudes from the first surface 306 of the panel 48c. The housing 408 includes a body 410 that at least partially surrounds the magnet 406. For example, the housing 408 surrounds (e.g., fully encircles) a circumference or perimeter of the magnet 406. In other words, the housing 408 of the illustrated example defines a cavity 412 to receive the magnet 406. In some examples, an outer surface 414 (e.g., a metal engaging surface) of the magnet 406 is substantially flush relative to an edge 416 (e.g., a leading edge) of the housing 408. As used herein, substantially flush means that the outer surface 414 of the magnet 406 slightly extends past the edge 416 of the housing 408 (e.g., by between approximately one millimeter and 1 inch), is even with the edge 416 (e.g., on the same vertical plane), or is slightly recessed within the cavity 412 relative to the edge 416 (e.g., by between approximately one millimeter and a quarter of an inch).

Additionally, the body 410 of the housing of the illustrated example includes a side surface 418 that provides a ramp-like shape between the magnet 406 and the first surface 306 of the panel 48c. The side surface 418 of the illustrated example is tapered between the edge 416 of the body 410 and the first surface 306. In this manner, the side surface 418 of the body 410 reduces or prevents instances of the panel 48c from catching or snagging on other structures or panels located in the trailer 12 when the panel 48c is moved inside the trailer 12.

To retain the restraint 300 to the panel 48c, the panel 48c of the illustrated example includes a fastener 420. The fastener 420 of the illustrated example is a screw that passes through an opening 422 (e.g., a central opening) of the magnet 406 and fastens (e.g., attaches) to the first surface 306 of the panel 48c. The first surface 306 of the panel 48c can include a second fastener (e.g., a nut) to receive (e.g., threadably receive) the fastener 420.

Referring to FIGS. 44A and 44B, the fastener of the illustrated example enables rotation of the magnet 406 about a longitudinal axis 424 of the fastener 420 (e.g., an axis perpendicular relative to the first surface 306). Further, the fastener 420 of the illustrated example is configured to enable the magnet 406 to wobble relative to the longitudinal axis 424 of the fastener 420. For example, a longitudinal axis 426 of the magnet 406 is shown coaxially aligned with the longitudinal axis 424 of the fastener 420 in FIG. 44A. In FIG. 44B, the longitudinal axis 426 of the magnet 406 is shown at an angle 428 relative to the longitudinal axis 424 of the fastener 420. Additionally, the magnet 406 of the illustrated example can rotate (e.g., spin) about the longitudinal axis 424 of the fastener 420. To enable the magnet 406 to rotate (e.g., spin) and/or to wobble relative to the fastener 420, the fastener 420 of the illustrated example can include a shank having a diameter that is smaller than a diameter of the opening 422 of the magnet 406, a bushing, a bearing and/or any other suitable fastener to enable the magnet 406 to rotate and/or wobble relative to the longitudinal axis 424 of the fastener 420. In some examples, the magnet 406 does not rotate and/or wobble relative to the longitudinal axis 424 of the fastener 420. In some examples, the magnet 406 can be fixed to the panel 48c without use of the housing 408. In some examples, the magnet 406 can be coupled or carried by a recess formed in the first surface 306. For example, the magnet 406 can be directly mounted embedded in the first surface 306 such that the outer surface 414 of the magnet 406 is flush mounted relative to the first surface 306 of the panel 48c. In some examples, one or more magnets 406 can be embedded (e.g., completely covered by the first surface 306) and/or formed with the panel 48c. In some examples, at least a portion of the first surface 306 of the panel 48c can be formed with a magnetic material.

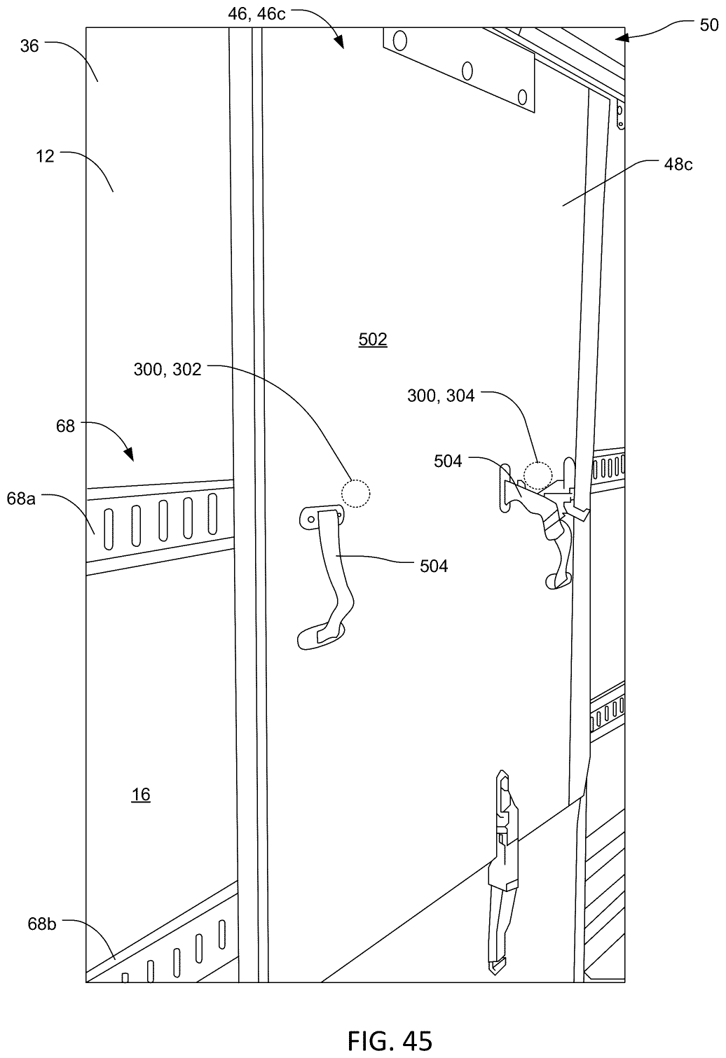

FIG. 45 is a perspective view of the panel 48c of FIG. 43 coupled to the trailer 12 via the restraint 300. The restraint 300 of the illustrated example interfaces with the logistic track 68 to secure (e.g., tie-down or hold) the panel 48c of bulkhead 46c to the trailer 12 when the panel 48c is not in use. Specifically, the magnets 406 of the first restraint 302 and the second restraint 304 magnetically couple or attach to the upper logistic track 68a to secure the panel 48c to the trailer 12. For example, the restraint 300 of the illustrated example is used in place of the clips 70, the buckles, straps 72, and anchors 112 of FIG. 7 to secure or couple the panel 48c to the trailer 12.

To facilitate maneuverability of the panel 48c relative to the logistic tracks 68 and/or the cargo storage area 16, a second surface 502 (e.g., an outer surface) of the panel 48c opposite the first surface 306 includes one or more handles 504. Additionally, the swivel joint 94 (FIG. 7) enables the panel 48c to rotate and/or swivel about the swivel joint 94 to enable maneuverability of the panel 48c relative to the logistic tracks 68. In the illustrated example, to secure the panel 48c to the upper logistic track 68a, an operator can grasp the handles 504 to move the panel 48c in the lateral direction 34 and/or the longitudinal direction 30 via the overhead track system 50 and/or rotate the panel 48c via the swivel joint 94 to align the first and second restraints 302 and 304 with the upper logistic track 68a. The operator can push or place the panel 48c against the upper logistic track 68a to enable the magnets 406 of the first restraint 302 and the second restraint 304 to magnetically engage the upper logistic track 68a. The magnets 406 hold the panel 48c in an upright position and prevent the panel 48c from moving in the lateral direction 34, the longitudinal direction 30 and/or the vertical direction 40 when the trailer 12 is moving and/or during a loading/unloading operation. To detach the panel 48c from the logistic tracks 68 (e.g., the upper logistic track 68a in the illustrated example), an operator can pull the panel 48c in a direction (e.g., the lateral direction 34) away from the logistic tracks 68 via, for example, the handles 504.

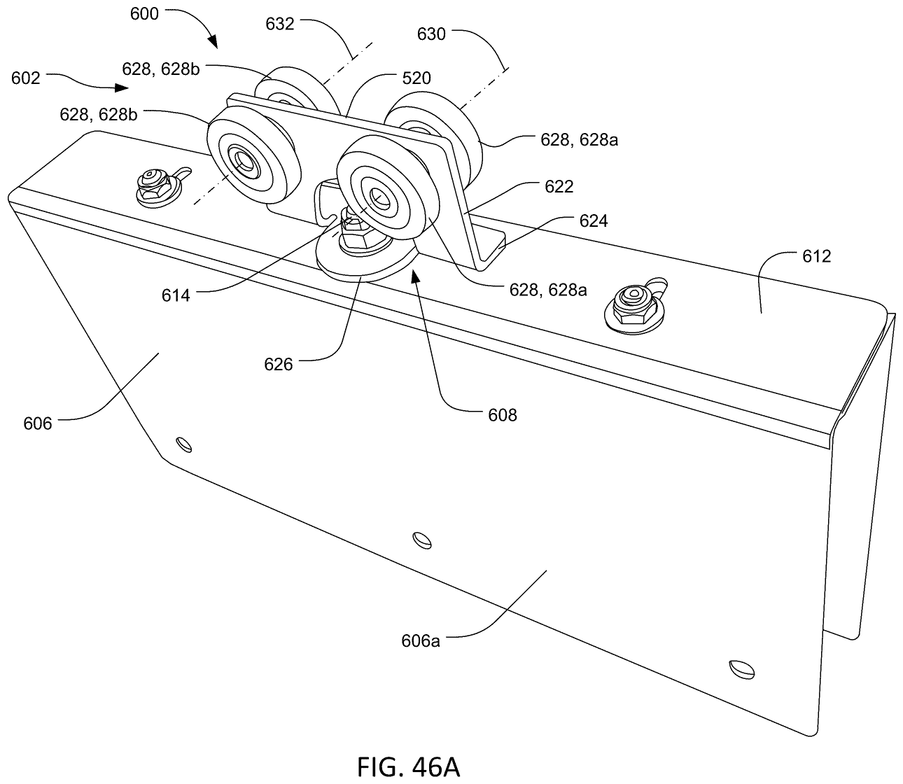

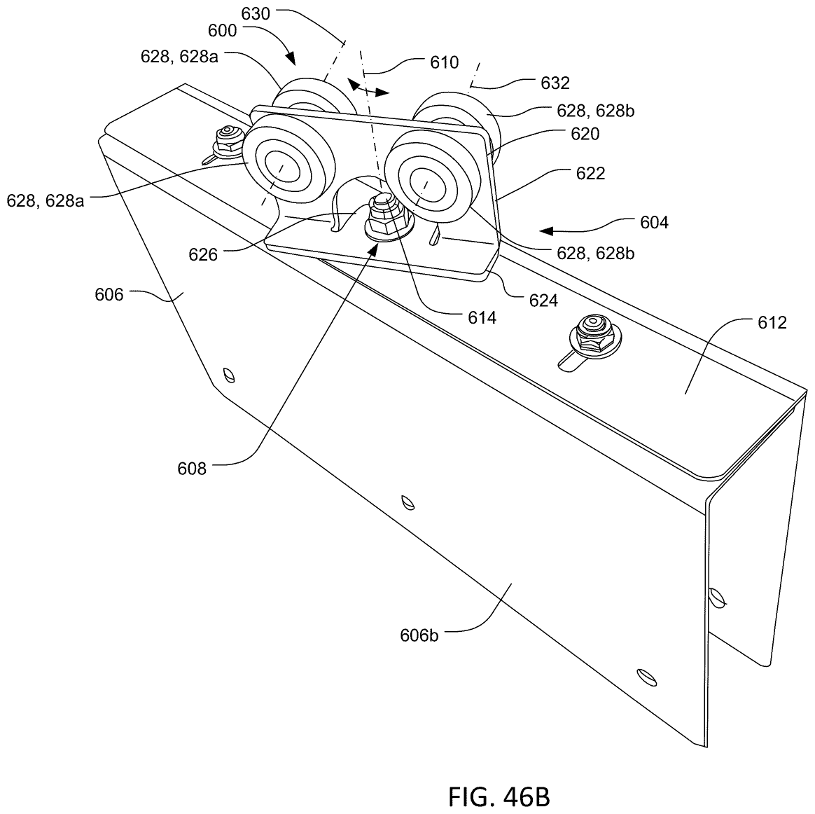

FIG. 46A is a perspective view of an example carriage 600 (e.g., a trolley) disclosed herein shown in an example first or non-rotated position 602. FIG. 46B is a perspective view of the example carriage 600 of FIG. 46A shown in an example second or rotated position 604. The example carriage 600 disclosed herein can implement the example system 50 and/or the bulkheads 46 of FIGS. 1-45. The carriage 600 of the illustrated example can implement the first carriage 86a and/or the second carriage 86b of FIGS. 1-45.

The carriage 600 of the illustrated example is structured to mount to an example panel 606. In some examples, the panel 606 of the illustrated example can implement the example panels 48 of FIGS. 1-45. The carriage 600 of the illustrated example is pivotally mounted to the panel 606 via a swivel joint 608 (e.g., the swivel joint 94 of FIG. 8). The swivel joint 608 of the illustrated example enables the panel 606 to rotate relative to the carriage 600 about a swivel axis 610 (e.g., the axis 52 of FIG. 8). The swivel axis 610 of the illustrated example is positioned between an upper surface 612 of the panel 606 between a first side 606a (FIG. 46A) of the panel 606 and a second side 606b (FIG. 46B) of the panel 606 opposite the first side 606a. The swivel joint 608 of the illustrated example includes a fastener 614 (e.g., a screw, a J-bolt of FIG. 8, a nut, a bolt, a washer, a clip, a clamp, a rivet, etc.) that couples the panel 606 to the carriage 600 and a core (e.g., the foam core 100) of the panel 606. The fastener 614 can also include a bushing or sleeve to enable the panel 606 to swivel relative to the carriage 600.

Referring to FIGS. 46A and 46B, to pivotally mount the carriage 600 of the illustrated example and the panel 606, the carriage 600 of the illustrated example includes a bracket 620. The bracket 620 of the illustrated example includes a body 622 and a flange 624. The flange 624 of the illustrated example protrudes from the body 622 in a direction away from (e.g., substantially perpendicular relative to an end of) the body 622. The flange 624 of the illustrated example includes a mounting tab 626 (e.g., a semi-circular tab or flange) to pivotally mount the bracket 620 and, thus, the carriage 600 to the panel 606. For example, the panel 606 can rotate relative to the flange 624 about the swivel axis 610. For example, the bracket 620 of the illustrated example can be formed from a plate (e.g., a unitary plate). The plate can be partially cut (e.g., a semi-circle, three-quarters of a circle, etc.) and a portion of the plate defining the body 622 can be bent (e.g., via a press) relative to the flange 624 and the tab 626 such that the body 622 is non-parallel (e.g., perpendicular) relative to the flange 624 and/or the tab 626. The body 622 of the illustrated example is parallel relative to swivel axis 610 and the flange 624 and the tab 626 are non-parallel (e.g., perpendicular) relative to the swivel axis 610.

The carriage 600 of the illustrated example couples to a lateral track (e.g., the rear lateral track 84a, the front lateral track 84b, etc.) of a system (e.g., the system 50). The carriage 600 movably couples the panel 606 within a cargo container of a vehicle, a rail car, a warehouse, and/or other transport or storage system(s) (e.g., modular storage system(s)). To movably couple the carriage 600 to a lateral track, the carriage 600 of the illustrated example includes a plurality of rollers 628. For example, the rollers 628 enable the panel 606 to move or slide along a lateral track (e.g., the rear lateral track 84a, the front lateral track 84b in the lateral direction 34 of FIG. 1).

The rollers 628 of the illustrated example are rotatably coupled to the body 622. The rollers 628 of the illustrated example include a first set 628a of rollers 628 that rotate relative to the body 622 about a first rotational axis 630 and a second set 628b of rollers 628 that rotate relative to the body 622 about a second rotational axis 632. In some examples, the carriage 600 can include only one roller 628 or only one set 628a or 628b of rollers 628. In some examples, the carriage 600 can include more than two sets of rollers 628 and/or any number of rollers 628.

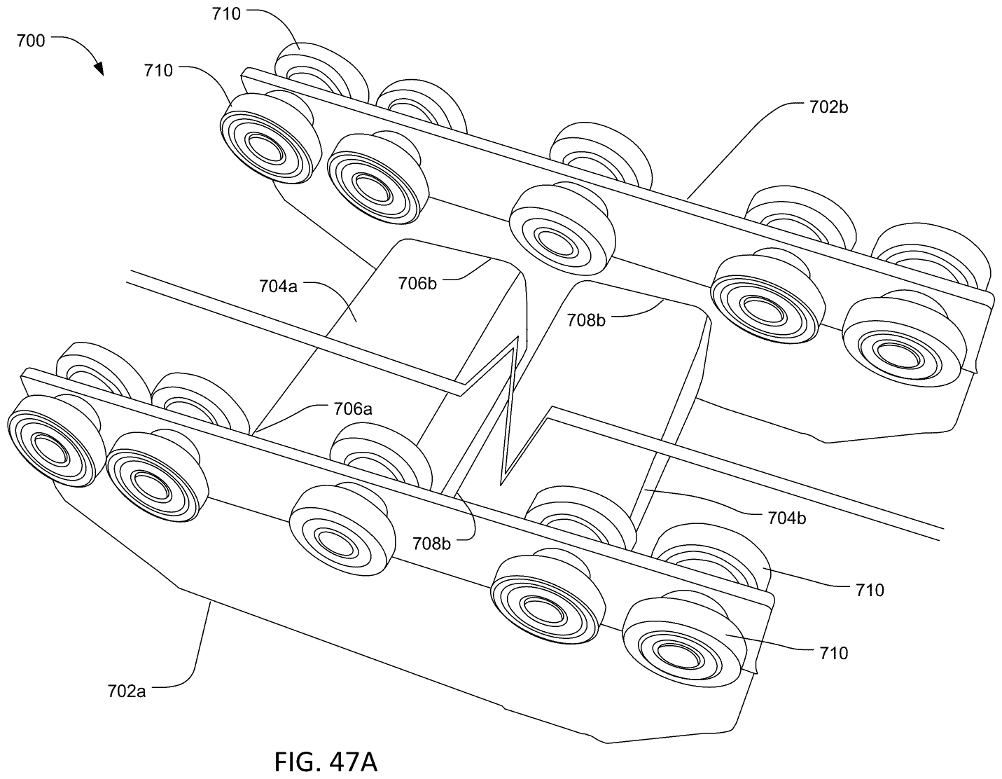

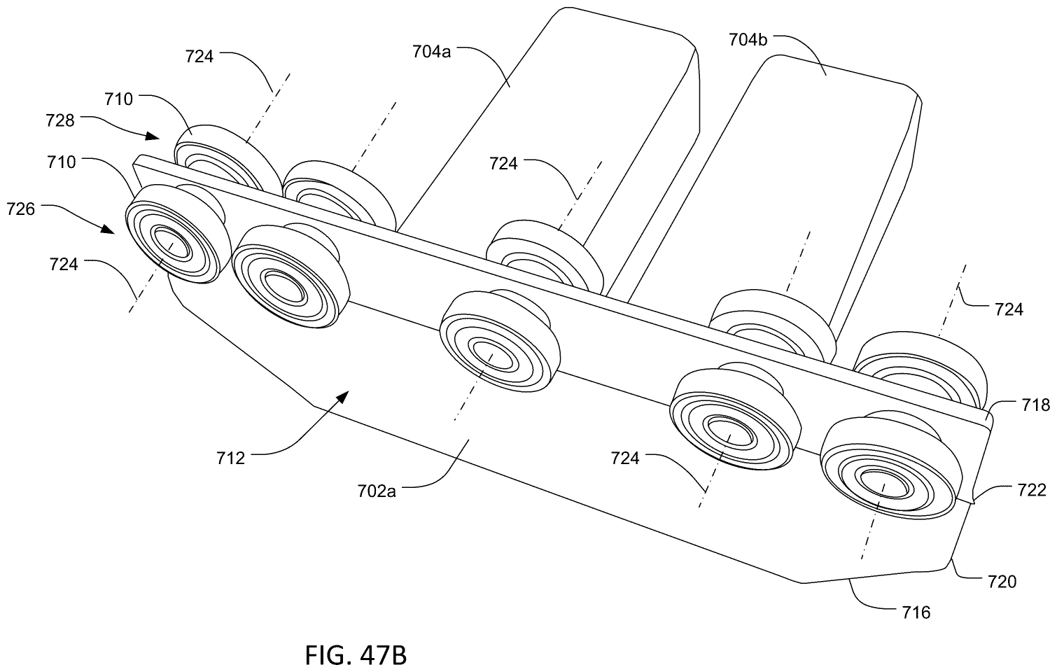

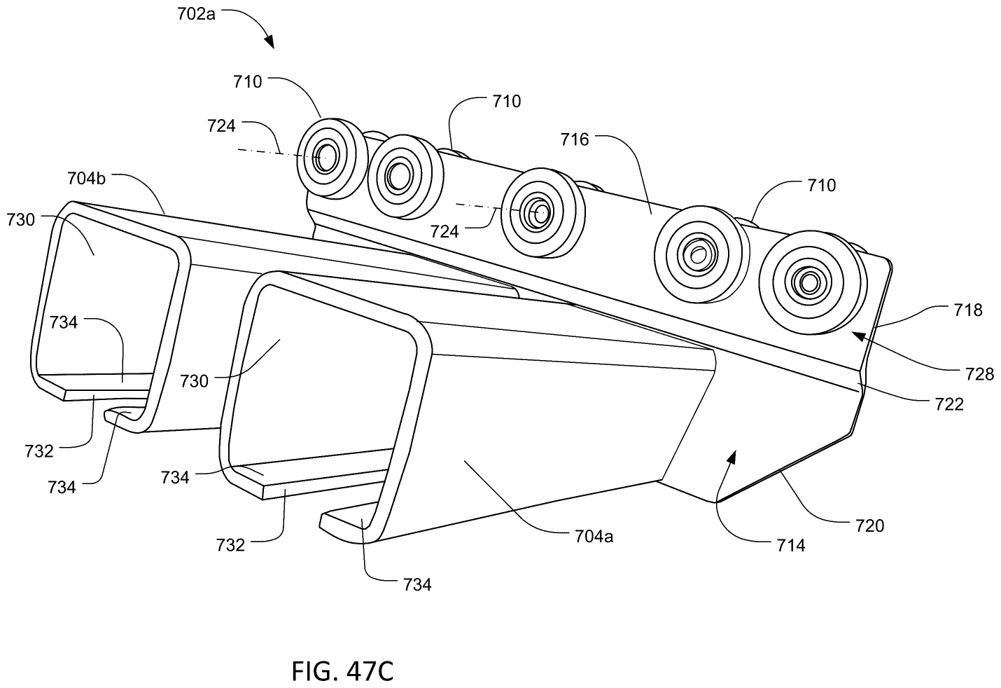

FIG. 47A is a perspective view of another example carriage assembly 700 (e.g., a trolley assembly) disclosed herein. FIG. 47B is a partial, perspective view of the example carriage assembly 700 of FIG. 47A. FIG. 47C is another partial, perspective view of the carriage assembly 700 of FIG. 47A. The carriage assembly 700 of the illustrated example can be used to implement example system 50 and/or the bulkheads 46 of FIGS. 1-45.

The carriage assembly 700 of the illustrated example includes a first carriage 702a (e.g., a first trolley) and a second carriage 702b (e.g., a second trolley). For example, the first carriage 702a can implement the right carriage 86c and/or the second carriage 702b can implement the left carriage 86d of FIGS. 1-45. The carriage assembly 700 of the illustrated example includes a first lateral track 704a and a second lateral track 704b positioned between the first carriage 702a and the second carriage 702b. A length of the first lateral track 704a and/or the second lateral track 704b can have any desired length. For example, the length of the first and second lateral tracks 704a, 704b (e.g., a width in the direction 34 of FIG. 1) can vary to fit between the first side wall 36 and the second side wall 36 of the cargo storage area 16. The first lateral track 704a of the illustrated example is a beam (e.g., a channeled or hollow beam) having a first end 706a and a second end 706b opposite the first end 706a. Likewise, the second lateral track 704b of the illustrated example is a beam (e.g., a channeled beam) having a first end 708a and a second end 708b opposite the first end 708a. The first carriage 702a is coupled to the first ends 706a, 706b of the respective first and second lateral tracks 704a, 704b and the second carriage 702b is coupled to the second ends 706b, 708b of the respective first and second lateral tracks 704a, 704b. In some examples, the first lateral track 704a can implement the right longitudinal track 84c and the second lateral track 604b can implement the left longitudinal track 84d of FIGS. 1-45. In some examples, the carriage assembly 700 of the illustrated example can include only a signal lateral track (e.g., the first lateral track 704a or the second lateral track 704b) or more than the first lateral track 704a and the second lateral track 704b (e.g., three lateral tracks, four lateral tracks, etc.). Each of the carriages 702a and 702b include a plurality of rollers 710. The rollers 710 of the first carriage 702a can engage a first longitudinal track (e.g., the right longitudinal track 84c) and the rollers 710 of the second carriage 702 of the illustrated example can engage a second longitudinal track (e.g., the left longitudinal track 84d) of a system (e.g., the system 50 of FIGS. 1-45).

FIG. 47B is a perspective view of the first carriage 702a showing a first side 712 of the first carriage 702a. FIG. 47C is a perspective view of the first carriage 702b showing a second side 714 of the first carriage 702a opposite the first side 712. The first carriage 702a of the illustrated example defines a body 716. The body 716 of the illustrated example includes a first portion 718 (e.g., an upper portion) and a second portion 720 (e.g., a lower portion) offset (e.g., in the vertical direction) relative to the first portion 718 to define a transition 722 (e.g., a step therebetween). The first portion 718 supports the rollers 710. Each of the rollers 710 rotates about a respective rotational axis 724. In the illustrated example, a first set 726 of rollers is positioned at (e.g., rotatably coupled to) the first side 712 of the first portion 718 and a second set 728 of rollers 710 is positioned (e.g., rotatably coupled to) the second side 714 of the first portion 718 opposite the first side 712. The rollers are structured to engage a longitudinal track (e.g., the right longitudinal track 84c, the left longitudinal track 84d, etc.). The second carriage 702b is substantially similar or identical to the first carriage 702a.

Referring to FIG. 47C, the first and second lateral tracks 704a, 704b each includes a channel 730 to receive the carriage 600 that supports the panel 606. For example, the channel 730 includes a slot 732 to receive the body 622 of the carriage 600 therebetween and rails 734 to receive or support (e.g., movably support) the respective rollers 628 of the carriage 600.

In operation, when the carriage assembly 700 of the illustrated example is coupled to a system (e.g., the system 50 of FIGS. 1-45), the carriage assembly 700 moves rearward and/or forward in a longitudinal direction (e.g., in a longitudinal direction 30 of FIG. 3), which causes the panels 606 coupled to the first lateral track 704a and/or the second lateral track 704b to move in the longitudinal direction with the carriage assembly 700. For example, the first carriage 702a moveably couples to a first longitudinal track of a system (e.g., the longitudinal track 84c of the system 50) via the rollers 710 of the first carriage 702a and the second carriage 702b moveably couples to a second longitudinal track of a system (e.g., the longitudinal track 84d of the system 50) via the rollers 710 of the second carriage 702b. As the first carriage 702a moves relative to a first longitudinal track and the second carriage 702b moves relative to the second longitudinal track, the first and second carriages 702a, 702b cause the first and second lateral tracks 704a, 704b and, thus, the panel 606 attached thereto via the carriage 600, to move in the longitudinal direction with the carriage assembly 700. The first lateral track 702a enables the carriage 600 and, thus, the panel 606 supported by the carriage 600 coupled to the first lateral track 704a to move laterally (e.g., sideways) between the first carriage 702a and the second carriage 702b, and the pivot joint 608 of the carriage 600 (FIG. 5) enables the panel 606 to rotate relative to the first lateral track 704a. Likewise, the second lateral track 704b enables the carriage 600 and, thus, the panel 606 supported by carriage 600 coupled to the second lateral track 704b to move laterally (e.g., sideways) between the first carriage 702a and the second carriage 702b, and the pivot joint 608 of the carriage 600 (FIG. 5) supporting the panel 606 enables the panel 606 to rotate relative to the second lateral track 704b.

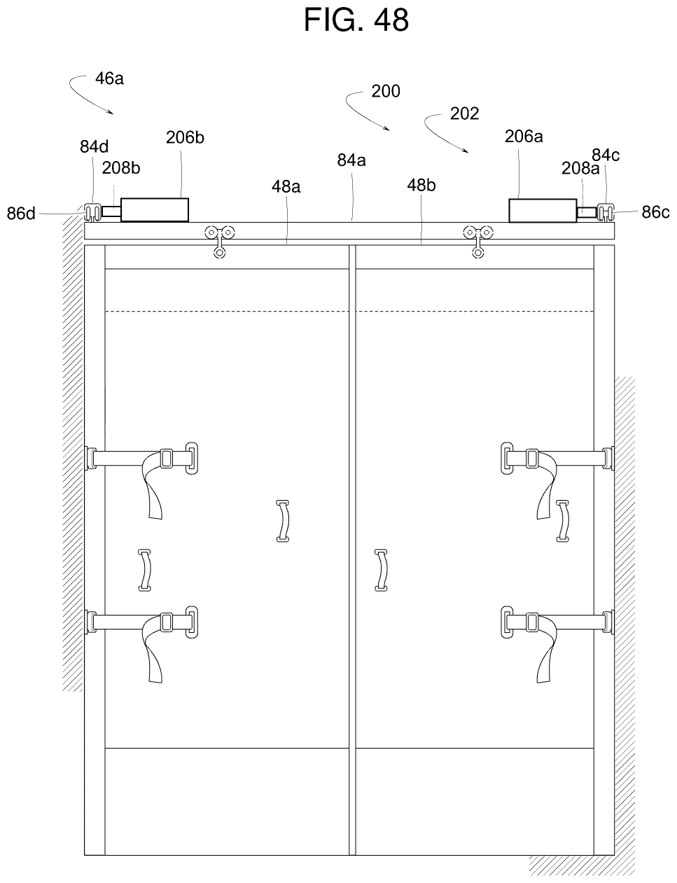

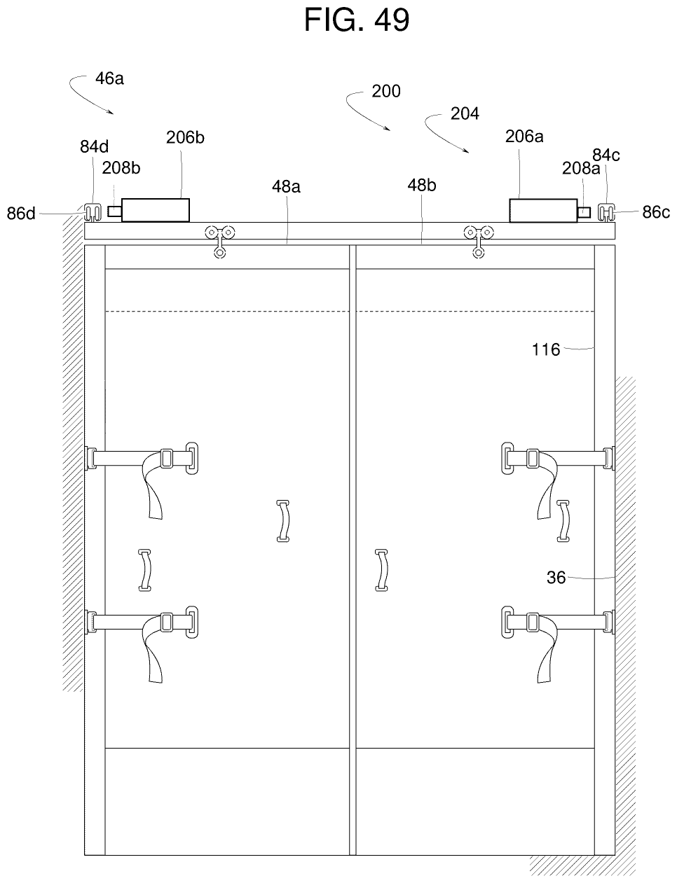

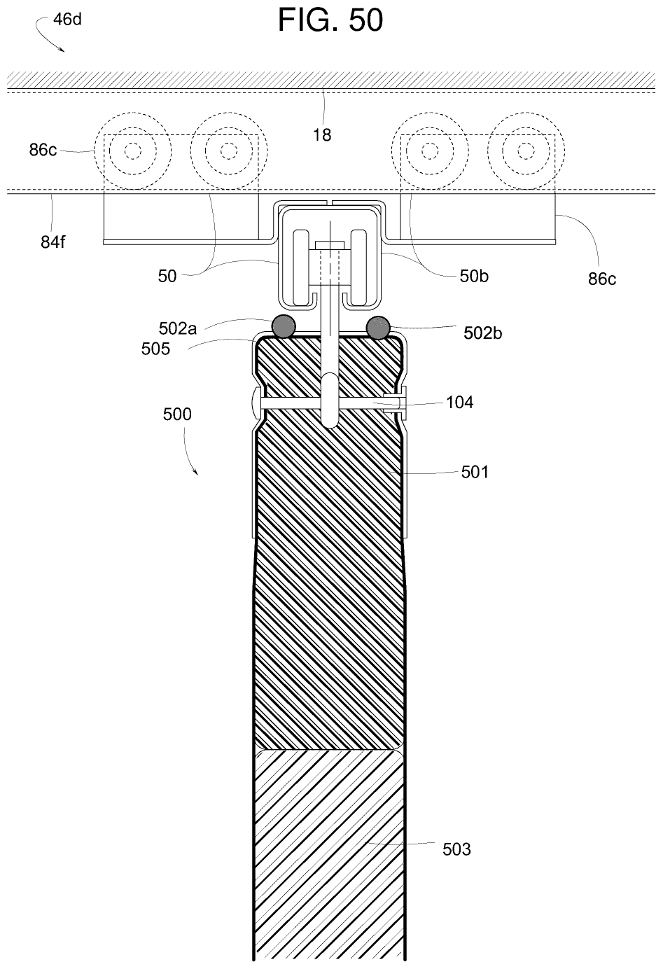

FIG. 48 and FIG. 49 illustrate the example bulkhead 46a with an example brake system 200 disclosed herein. The brake system 200 of the illustrated example is shown in an example active/engaged state 202 in FIG. 48 and a release state 204 in FIG. 49. The brake system 200 of the illustrated example secures or prevents movement of the bulkhead 46a (e.g., the first panel 48a and the second panel 48b via the lateral track 84a) relative to the longitudinal tracks 84c and 84d. Thus, the brake system 200 of the illustrated example selectively prevents or reduces movement of the panels 48a, 48b in the longitudinal direction. The brake system 200 of the illustrated example includes a first brake 206a and a second brake 206b. The first brake 206a and the second brake 206b of the illustrated example are supported or coupled to (e.g., mounted or fixed to) the lateral track 84a (e.g., to an outer surface of the beam defining the lateral track 84a).

The first brake 206a is associated with the first longitudinal track 84c and the second brake 206b is associated with the second longitudinal track 84d. Specifically, the first brake 206 includes a first retractable arm (e.g., a plunger, a rubber plunger, a pin etc.) moveable for engagement with (e.g., an outer surface of, an aperture or detent in, etc.) the right longitudinal track 84c and the second brake 206b includes a second retractable arm 208b (e.g., a plunger, a rubber plunger, a pin, etc.) moveable for engagement with (e.g., an outer surface of, an aperture or detent in, etc.) the left longitudinal track 84d.

In the brake condition 202 of FIG. 48, the first arm 208a is in engagement (e.g., frictional engagement) with right longitudinal track 84c and the second arm 208b is in engagement (e.g., frictional engagement) with the left longitudinal track 84d. In the brake position 202, engagement between the first and second arms 208a, 208b and contacted surfaces of the respective right and left longitudinal tracks 84c, 84d prevents or restricts movement of the first panel 48a and the second track 48b along the longitudinal tracks 84c, 84d (e.g., in a longitudinal direction). In other words, the first arm 208a imparts a force against a surface of the right longitudinal track 84c and the second arm 208b imparts a force to a surface of the left longitudinal track 84d. The brake system 200 can secure a position of the first panel 48a and the second panel 48b longitudinally within a cargo space when the container is moving.

To enable desired movement of the first panel 48a and the second panel 48b along the longitudinal tracks 84c and 84d, the brake system 200 of the illustrated example is moved to the release position 204 of FIG. 49. In the release position 204, the first and second arms 208a and 208b of the respective first and second brakes 206a and 206b disengage or release the outer surfaces of the respective longitudinal tracks 84c, 84d. Absent the frictional engagement provided by the brake system 200 when in the brake position 202 of FIG. 48, the lateral track 84a including the first panel 48a and the second panel 48b, is free to move along the longitudinal tracks 84c, 84d via the trolleys 86c, 86d. Although only the lateral track 84a is shown having the brake system 200, in some examples, either or both of the lateral tracks can include the brake system 200.

The first brake 206a and/or the second brake 206b can include a motor, a step motor, a hydraulic actuator, an electric actuator, a manual actuator and/or any other actuator. In some examples, a controller (e.g., a push button controller) is provided to operate the first brake 206a and the second brake 206b between the engaged position 202 and the release position 204. In some examples, the brake system 200 is a manually operated drive system 200. For example, pull cords can be provided to move the first and second arms 208a and 208b into and out of engagement with the respective longitudinal tracks 84c, 84d. For example, the first arm 208a and the second arm 208b can be biased (e.g., via a biasing element or spring) in the brake position 202 and the pull cords can be used to pull the arms 208a and 208b against the biasing force and out of engagement with the longitudinal tracks 84c, 84d while the bulkhead 46a is being positioned longitudinally in the cargo space.

FIG. 50 illustrates another example bulkhead 46d disclosed herein. The bulkhead 46 of the illustrated example includes a flexible panel 500. The flexible panel 500 includes a first core 501 and a second core 503 composed of non-rigid or flexible material(s). The first core 501 and the second core 503 are flexible or pliable core sections. In some examples, the first core 501 is composed of the same material as the second core 503.

In the illustrated example of FIG. 50, a stiffener 502a is provided along or adjacent an upper edge (e.g., a horizontal edge) of the flexible panel 500 for increased flexural beam rigidity to prevent upper lateral edge of the panel 500 from drooping as a result of its weight and flexibility as it hangs from the overhead track system 500 (e.g., from a single central point). In the illustrated example, the panel 500 includes a first stiffener 502a positioned adjacent a first edge of the upper surface and a second stiffener 502b positioned adjacent a second edge of the upper surface opposite the first edge. In the illustrated example, the first and second stiffeners 502a, 502b are provided on an outer surface of the flexible panel 500 (e.g., in respective pockets or loops formed of or attached to the upper surface). In some examples, the first stiffener 502a and/or the second stiffener 502b can be positioned within the flexible panel 500 (e.g., within the first core 501 above and/or below the screw 104). The stiffeners 502a and 502b of the illustrated example can be fiberglass, metal, plastic, and/or any other material(s). Additionally, in some examples, only one stiffener 502a is employed or more than two stiffeners can be employed.

The foregoing examples of the bulkheads 46, the overhead track systems 50 and/or other components (e.g., panels 48, 606 the joint 92, 608, the hanger 106, the carriages 86, 600, 702a, 702b, the carriage assembly 700, the tracks 84 (e.g., 84a-d, 604a, 704d, etc.), the brake system 200 disclosed herein can be employed with a cargo container of a vehicle, a rail car, a warehouse and/or any other transport or storage system (e.g., modular storage system(s)). Although each example of the bulkheads 46, the overhead track systems 50 and/or other components (e.g., the panels 48, 606, the joint 92, 608, the hanger 106, the carriages 86, 600, 702a, 702b, the carriage assembly 700, the tracks 84 (the tracks 84a-d, 704a, 704b, etc.), the brake system 200 disclosed above have certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Example methods, apparatus, systems, and articles of manufacture to implement bulkheads are disclosed herein. Further examples and combinations thereof include the following:

Example 1 includes a bulkhead including an overhead track system mountable to an enclosed cargo transporter within a cargo storage area. A first carriage is attached to the overhead track system. The first carriage is movable relative to the overhead track system in at least one of a lateral direction or a longitudinal direction while being guided by the overhead track system. A first panel is suspended by the first carriage from the overhead track system, where the weight of the first panel is substantially supported by the overhead track system via the first carriage.

Example 2 includes the bulkhead of example 1, where the first carriage is movable in the lateral direction over a lateral distance that is greater than one third of a panel width of the first panel.

Example 3 includes the bulkhead of examples 1 or 2, where the first panel has a first swivel range of motion of at least 45 degrees about a first vertical axis relative to the overhead track system.

Example 4 includes the bulkhead of any one of examples 1-3, further including a second panel suspended by a second carriage from the overhead track system, the second carriage providing the second panel with a second swivel range of motion of at least 45 degrees about a second vertical axis relative to the overhead track system, wherein the second vertical axis is laterally spaced apart from a first vertical axis of the first panel.

Example 5 includes the bulkhead of any one of examples 1-4, where the overhead track system includes a first lateral track and a second lateral track that extend in the lateral direction, the first lateral track oriented substantially parallel to the second lateral track, the first carriage being movable along and guided by the first lateral track, and the second carriage being movable along and guided by the second lateral track.

Example 6 includes the bulkhead of any one of examples 1-5, where the overhead track system includes a common lateral track defining a substantially linear path extending in the lateral direction, the first carriage and the second carriage being movable along the substantially linear path.

Example 7 includes the bulkhead of any one of examples 1-6, where the first carriage is at a spaced-apart distance from the second carriage, the spaced-apart distance being adjustable along the overhead track system to vary a distance by which the first panel overlaps the second panel in the lateral direction.

Example 8 includes the bulkhead of any one of examples 1-7, further including a seal positioned between the overhead track system and an interior surface of the cargo transporter.

Example 9 includes the bulkhead of any one of examples 1-8, further including a releasable coupling between the first panel and the second panel, the releasable coupling being vertically elongate.

Example 10 includes the bulkhead of any one of examples 1-9, where the first panel includes a pliable core section.

Example 11 includes the bulkhead of any one of examples 1-10, further including at least one longitudinal stiffener positioned along an edge of the first panel.

Example 12 includes the bulkhead of any one of examples 1-11, where the first panel includes an upper section, a replaceable lower section, and a restorably disconnectable joint connecting the replaceable lower section and the upper section, the replaceable lower section having a lower section height that is between 20% and 50% of the upper section height.

Example 13 includes the bulkhead of any one of examples 1-12, where the first carriage is movable in both the longitudinal direction and the lateral direction along the overhead track system.

Example 14 includes the bulkhead of any one of examples 1-13, where the first panel includes a draw latch strap for securing the panel to an interior lateral surface of the cargo transporter.

Example 15 includes a bulkhead including for use in a cargo storage area of an enclosed cargo transporter, the cargo storage area having a storage length extending in a longitudinal direction, a storage width extending in a lateral direction, and storage height extending in a vertical direction, the bulkhead comprising: an overhead track system mountable to the enclosed cargo transporter within the cargo storage area; a first carriage attached to the overhead track system, the first carriage being movable along the overhead track system along a lateral distance in the lateral direction, the first carriage to move along the overhead track system in the longitudinal direction; and a first panel suspended by the first carriage from the overhead track system.

Example 16 includes the bulkhead of example 15, where the first panel having a panel width, and the lateral distance of the first carriage being greater than one third of the panel width.

Example 17 includes the bulkhead of examples 15 or 16, where the first carriage is structured to enable the first panel to swivel along a first swivel range of motion of at least 45 degrees about a first vertical axis.

Example 18 includes the bulkhead of any one of examples 15-17, further including a second carriage being movable in a longitudinal direction and lateral direction along the overhead track system; and a second panel suspended from the second carriage, the second carriage providing the second panel with a second swivel range of motion of at least 45 degrees about a second vertical axis.

Example 19 includes the bulkhead of any one of examples 15-18, the overhead track system includes a first lateral track and a second lateral track that extend in the lateral direction, the first lateral track being substantially parallel to the second lateral track, the first carriage being movable along and guided by the first lateral track, and the second carriage being movable along and guided by the second lateral track.

Example 20 includes the bulkhead of any one of examples 15-19, further including a seal positioned between the overhead track system and an interior surface of the cargo transporter.

Example 21 includes the bulkhead of any one of examples 15-20, where the overhead track system includes a common lateral track defining a substantially linear path extending in the lateral direction, both the first carriage and the second carriage being movable along the substantially linear path.

Example 22 includes the bulkhead of any one of examples 15-21, where the first carriage is at a spaced-apart distance from the second carriage, the spaced-apart distance being adjustable along the overhead track system to vary an amount that the first panel overlaps the second panel in the lateral direction.

Example 23 includes the bulkhead of any one of examples 15-22, where further including a releasable coupling between the first panel and the second panel, the releasable coupling being vertically elongate.

Example 24 includes the bulkhead of any one of examples 15-23, where the first panel includes a pliable core section.

Example 25 includes the bulkhead of any one of examples 15-24, further including at least one longitudinal stiffener positioned along an edge of the first panel

Example 26 includes the bulkhead of any one of examples 15-25, where the first panel includes an upper section, a replaceable lower section, and a restorably disconnectable joint connecting the replaceable lower section and the upper section, the replaceable lower section having a lower section height that is approximately between 20% and 50% of an upper section height.

Example 27 includes the bulkhead of any one of examples 15-26, where the first panel includes a draw latch strap for securing the panel to an interior lateral surface of the cargo transporter.

Example 28 includes the bulkhead of any one of examples 15-27, further including a brake system to selectively reduce or prevent movement of the first carriage in the longitudinal direction.

Example 29 includes a bulkhead for use in a cargo storage area of an enclosed cargo transporter, the cargo storage area having a storage length extending in a longitudinal direction, a storage width extending in a lateral direction, and storage height extending in a vertical direction, the bulkhead including: an overhead track system mountable to the enclosed cargo transporter within the cargo storage area; a carriage attached to the overhead track system, the carriage being movable relative to the overhead track system in at least one of the lateral direction or the longitudinal direction; a panel suspended by the carriage from the overhead track system, the panel including an upper section and a replaceable lower section, the upper section being attached to the carriage, the upper section having an upper section height, the replaceable lower section having a lower section height that is approximately between 20% and 50% of the upper section height; and a restorably disconnectable joint connecting the replaceable lower section and the upper section

Example 30 includes the bulkhead of example 29, where the carriage provides the panel with a first swivel range of motion of at least 45 degrees about a first vertical axis.

Example 31 includes the bulkhead of examples 29 or 30, where the panel includes a pliable core section.

Example 32 includes the bulkhead of any one of examples 29-31, the carriage is movable in the lateral direction over a lateral distance that is greater than one third of a panel width of the panel.

Example 33 includes the bulkhead of any one of examples 29-32, the carriage is movable in the lateral direction and the longitudinal direction relative to the overhead track system.

Example 34 includes a bulkhead for use in a cargo storage area of an enclosed cargo transporter, the cargo storage area having a storage length extending in a longitudinal direction, a storage width extending in a lateral direction, and storage height extending in a vertical direction, the bulkhead comprising: an overhead track system mountable to the enclosed cargo transporter within the cargo storage area; a carriage attached to the overhead track system, the carriage being movable relative to the overhead track system in at least one of the lateral direction or the longitudinal direction while being guided by the overhead track system; a panel suspended by the carriage from the overhead track system; and a restraint carried by the panel, the restraint to secure the panel to a wall of the cargo storage area to restrict movement of the panel during at least one of movement of the cargo storage area or an unloading/loading operation.

Example 35 includes the bulkhead of example 34, where the restraint includes a magnet to magnetically engage a logistic track of the cargo storage area to secure the panel to the wall of the cargo storage area.

Example 36 includes the bulkhead of examples 34 or 35, where the restraint includes a housing having a cavity to at least partially receive the magnet, the housing having a side surface that tapers between a leading edge of the housing and a surface of the panel.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A bulkhead for use in a cargo storage area of an enclosed cargo transporter, the cargo storage area having a storage length extending in a longitudinal direction, a storage width extending in a lateral direction, and storage height extending in a vertical direction, the bulkhead comprising:
an overhead track system mountable to the enclosed cargo transporter within the cargo storage area;
a first carriage attached to the overhead track system, the first carriage being movable relative to the overhead track system in at least one of the lateral direction or the longitudinal direction while being guided by the overhead track system; and
a first panel to be suspended by the first carriage from the overhead track system, wherein the weight of the first panel is substantially supported by the overhead track system via the first carriage.

2. The bulkhead of claim 1, wherein the first carriage is movable in the lateral direction over a lateral distance that is greater than one third of a panel width of the first panel.

3. The bulkhead of claim 1, wherein the first panel has a first swivel range of motion of at least 45 degrees about a first vertical axis relative to the overhead track system.

4. The bulkhead of claim 1, further including a second panel suspended by a second carriage from the overhead track system, the second carriage providing the second panel with a second swivel range of motion of at least 45 degrees about a second vertical axis relative to the overhead track system, wherein the second vertical axis is laterally spaced apart from a first vertical axis of the first panel.

5. The bulkhead of claim 4, wherein the overhead track system includes a first lateral track and a second lateral track that extend in the lateral direction, the first lateral track oriented substantially parallel to the second lateral track, the first carriage being movable along and guided by the first lateral track, and the second carriage being movable along and guided by the second lateral track.

6. The bulkhead of claim 4, wherein the overhead track system includes a common lateral track defining a substantially linear path extending in the lateral direction, the first carriage and the second carriage being movable along the substantially linear path.

7. The bulkhead of claim 4, wherein the first carriage is at a spaced-apart distance from the second carriage, the spaced-apart distance being adjustable along the overhead track system to vary a distance by which the first panel overlaps the second panel in the lateral direction.

8. The bulkhead of claim 7, further including a seal positioned between the overhead track system and an interior surface of the cargo transporter.

9. The bulkhead of claim 4, further including a releasable coupling between the first panel and the second panel, the releasable coupling being vertically elongate.

10. The bulkhead of claim 1, wherein the first panel includes a pliable core section.

11. (canceled)

12. The bulkhead of claim 1, wherein the first panel includes an upper section, a replaceable lower section, and a restorably disconnectable joint connecting the replaceable lower section and the upper section, the replaceable lower section having a lower section height that is between 20% and 50% of the upper section height.

13. (canceled)

14. The bulkhead of claim 1, wherein the first panel includes a draw latch strap for securing the panel to an interior lateral surface of the cargo transporter.

15. A bulkhead for use in a cargo storage area of an enclosed cargo transporter, the cargo storage area having a storage length extending in a longitudinal direction, a storage width extending in a lateral direction, and storage height extending in a vertical direction, the bulkhead comprising:
an overhead track system mountable to the enclosed cargo transporter within the cargo storage area;
a first carriage attached to the overhead track system, the first carriage being movable along the overhead track system along a lateral distance in the lateral direction, the first carriage to move along the overhead track system in the longitudinal direction; and
a first panel suspended by the first carriage from the overhead track system, the first panel having a panel width, and the lateral distance of the first carriage being greater than one third of the panel width.

16. The bulkhead of claim 15, the first panel having a panel width, and the lateral distance of the first carriage being greater than one third of the panel width.

17. (canceled)

18. The bulkhead of claim 15, further comprising:
a second carriage being movable in a longitudinal direction and lateral direction along the overhead track system; and
a second panel suspended from the second carriage, the second carriage providing the second panel with a second swivel range of motion of at least 45 degrees about a second vertical axis.

19. The bulkhead of claim 18, wherein the overhead track system includes a first lateral track and a second lateral track that extend in the lateral direction, the first lateral track being substantially parallel to the second lateral track, the first carriage being movable along and guided by the first lateral track, and the second carriage being movable along and guided by the second lateral track.

20. (canceled)

21. (canceled)

22. (canceled)

23. (canceled)

24. (canceled)

25. (canceled)

26. (canceled)

27. (canceled)

28. The bulkhead of claim 15, further including a brake system to selectively reduce or prevent movement of the first carriage in the longitudinal direction.

29. (canceled)

30. (canceled)

31. (canceled)

32. (canceled)

33. (canceled)

34. A bulkhead for use in a cargo storage area of an enclosed cargo transporter, the cargo storage area having a storage length extending in a longitudinal direction, a storage width extending in a lateral direction, and storage height extending in a vertical direction, the bulkhead comprising:
an overhead track system mountable to the enclosed cargo transporter within the cargo storage area;
a carriage attached to the overhead track system, the carriage being movable relative to the overhead track system in at least one of the lateral direction or the longitudinal direction while being guided by the overhead track system;
a panel suspended by the carriage from the overhead track system; and
a restraint carried by the panel, the restraint to secure the panel to a wall of the cargo storage area to restrict movement of the panel during at least one of movement of the cargo storage area or an unloading/loading operation.

35. The bulkhead of claim 34, wherein the restraint includes a magnet to magnetically engage a logistic track of the cargo storage area to secure the panel to the wall of the cargo storage area.

36. The bulkhead of claim 35, wherein the restraint includes a housing to having a cavity to at least partially receive the magnet, the housing having a side surface that tapers between a leading edge of the housing and a surface of the panel.
